(19) United States
(12) Patent Application Publication
(10) Pub. No.: US 2026/0332319 A1
(43) Pub. Date: Oct. 22, 2026

(54) BASE STATION AND METHOD FOR SIMULTANEOUS TCI STATE UPDATE OPERATION

(71) Applicant: SHARP KABUSHIKI KAISHA, Sakai City, Osaka (JP)

(72) Inventors: WAN-CHEN LIN, Taipei (TW); CHIA-HUNG LIN, Taipei (TW); MEI-JU SHIH, Taipei (TW); PO-CHUN CHOU, Taipei (TW)

(21) Appl. No.: 19/108,718

(22) PCT Filed: Sep. 15, 2023
(86) PCT No.: PCT/CN2023/119231

§ 371 Date: Mar. 4, 2025

Related U.S. Application Data
(60) Provisional application No. 63/407,406, filed on Sep. 16, 2022.
(60) Provisional application No. 63/432,354, filed on Dec. 13, 2022.
(60) Provisional application No. 63/438,683, filed on Jan. 12, 2023.

(51) Int. Cl. H04L 5/00

(52) U.S. Cl. CPC H04L 5/001; H04L 5/0094

(57) ABSTRACT

A method for a simultaneous Transmission Configuration Indication (TCI) state update operation performed by a base station (BS) is provided. The method includes transmitting a first Radio Resource Control (RRC) configuration for configuring a first component carrier (CC) list for simultaneous TCI state update operation; transmitting a second RRC configuration for configuring a second CC list for simultaneous TCI state update operation; transmitting a first TCI configuration that associates a plurality of TCI states with a first CC in the first CC list; and transmitting a second TCI configuration that associates a single TCI state with a second CC in the second CC list. Each CC in the first CC list is associated with the first TCI configuration, and each CC in the second CC list is associated with the second TCI configuration.

### FIELD

The present disclosure is related to wireless communication and, more specifically, to a base station (BS) and method for a simultaneous Transmission Configuration Indication (TCI) state update operation in cellular wireless communication networks.

### BACKGROUND

Various efforts have been made to improve different aspects of wireless communication for cellular wireless communication systems, such as 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to increase, there exists a need for further improvements in the art.

### SUMMARY

The present disclosure is related to a BS and a method for a simultaneous TCI state update operation in cellular wireless communication networks.

In a first aspect of the present application, a method for a simultaneous TCI state update operation performed by a BS is provided. The method includes transmitting a first Radio Resource Control (RRC) configuration for configuring a first component carrier (CC) list for simultaneous TCI state update operation; transmitting a second RRC configuration for configuring a second CC list for simultaneous TCI state update operation; transmitting a first TCI configuration that associates a plurality of TCI states with a first CC in the first CC list; and transmitting a second TCI configuration that associates a single TCI state with a second CC in the second CC list. Each CC in the first CC list is associated with the first TCI configuration, and each CC in the second CC list is associated with the second TCI configuration.

In an implementation of the first aspect, the first CC list and the second CC list correspond to different RRC parameters.

In another implementation of the first aspect, the first CC corresponds to a first reference cell for the first CC list, and the second CC corresponds to a second reference cell for the second CC list.

In another implementation of the first aspect, no TCI state configuration is configured to any CC in the first CC list other than the first CC, and no TCI state configuration is configured to any CC in the second CC list other than the second CC.

In another implementation of the first aspect, the single TCI state indicated by the second TCI configuration is a Downlink (DL) TCI state, a joint TCI state, or an Uplink (UL) TCI state.

In another implementation of the first aspect, the plurality of TCI states indicated by the first TCI configuration are a pair of DL TCI states, a pair of joint TCI states, a pair of UL TCI states, or a pair of DL/UL TCI states.

In another implementation of the first aspect, at least one of the first RRC configuration or the second RRC configuration is included in an RRC reconfiguration message.

In another implementation of the first aspect, at least one CC in the first CC list or in the second CC list corresponds to a non-serving cell.

In another implementation of the first aspect, the first CC corresponds to a first serving cell index and the second CC corresponds to a second serving cell index.

In another implementation of the first aspect, the method further includes transmitting a first Medium Access Control (MAC) Control Element (CE) for activating the plurality of TCI states for all CCs in the first CC list; and transmitting a second MAC CE for activating the single TCI state for all CCs in the second CC list.

In a second aspect of the present application, a BS for a simultaneous TCI state update operation is provided. The BS includes one or more processors and at least one memory coupled to at least one of the one or more processors, the at least one memory storing computer-executable instructions that, when executed by the at least one of the one or more processors, cause the BS to transmit a first RRC configuration for configuring a first CC list for simultaneous TCI state update operation; transmit a second RRC configuration for configuring a second CC list for simultaneous TCI state update operation; transmit a first TCI configuration that associates a plurality of TCI states with a first CC in the first CC list; and transmit a second TCI configuration that associates a single TCI state with a second CC in the second CC list. Each CC in the first CC list is associated with the first TCI configuration, and each CC in the second CC list is associated with the second TCI configuration.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process for a simultaneous TCI state update operation performed by a BS, according to an example implementation of the present disclosure.

FIG. 2 is a block diagram illustrating a node for wireless communication, according to an example implementation of the present disclosure.

### DESCRIPTION

Some abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AL | Aggregation Level |
| BFD | Beam Failure Detection |
| BS | Base Station |
| BW | Bandwidth |
| BWP | Bandwidth Part |
| CA | Carrier Aggregation |
| CC | Component Carrier |
| CCE | Control Channel Elements |
| CG | Configured Grant |
| CJT | Coherent Joint Transmission |
| CORESET | Control Resource Set |
| CP | Cyclic Prefix |
| CPA | Conditional PSCell Addition |
| CPAC | Conditional PSCell Change/Addition |
| CPC | Conditional PSCell Change |
| CRC | Cyclic Redundancy Check |
| CSI | Channel State Information |
| CSI-RS | Channel State Information Reference Signal |
| CU | Centralized Unit |
| DC | Dual Connectivity |
| DCI | Downlink Control Information |
| DG | Dynamic Grant |
| DL | Downlink |
| DU | Distributed Unit |
| DM-RS | Demodulation Reference Signal |
| E-UTRA | Evolved Universal Terrestrial Radio Access |
| FDM | Frequency Division Multiplexing |
| FR | Frequency Range |
| HARQ | Hybrid Automatic Repeat Request |
| HARQ-ACK | HARQ Acknowledgement |
| ICBM | Inter-Cell Beam Management |
| ID | Identifier |
| IE | Information Element |
| LTE | Long Term Evolution |
| LTM | Lower-Layer Triggered Mobility |
| MAC | Medium Access Control |
| MAC CE | MAC Control Element |
| MCG | Master Cell Group |
| MCS | Modulation Coding Scheme |
| MIMO | Multi-Input Multi-Output |
| MN | Master Node |
| mTRP | Multiple TRP |
| NR | New Radio |
| NW | Network |
| OFDM | Orthogonal Frequency Division Multiplexing |
| PBCH | Physical Broadcast Channel |
| PCell | Primary Cell |
| PCI | Physical Cell ID |
| PDCCH | Physical Downlink Control Channel |
| PDCP | Packet Data Convergence Protocol |
| PDSCH | Physical Downlink Shared Channel |
| PHY | Physical (layer) |
| PRACH | Physical Random Access Channel |
| PSCell | Primary SCG Cell |
| PT-RS | Phase Tracking Reference signal |
| PUCCH | Physical Uplink Control Channel |
| PUSCH | Physical Uplink Shared Channel |
| QCL | Quasi-CoLocation |
| RA | Random Access |
| RAN | Radio Access Network |
| RAR | Random Access Response |
| RF | Radio Frequency |
| RLC | Radio Link Control |
| RNTI | Radio Network Temporary Identifier |
| RRC | Radio Resource Control |
| RS | Reference Signal |
| RX | Reception |
| SCell | Secondary Cell |
| SCG | Secondary Cell Group |
| SDM | Space Division Multiplexing |
| SFN | Single Frequency Network |
| SI | System Information |
| SN | Secondary Node |
| SpCell | Special Cell |
| SR | Scheduling Request |
| SRI | SRS Resource Indicator |
| SRS | Sounding Reference Signal |
| SS | Synchronization Signal |
| SSB | Synchronization Signal Block |
| sTRP | Single TRP |
| STxMP | Simultaneous Transmission across Multiple Panels |
| TA | Timing Advance |
| TAG | Timing Advance Group |
| TB | Transport Block |
| TCI | Transmission Configuration Indication |
| TDM | Time Division Multiplexing |
| TR | Technical Report |
| TRP | Transmission Reception Point |
| TRS | Tracking Reference Signal |
| TS | Technical Specification |
| TX | Transmission |
| UCI | Uplink Control Information |
| UE | User Equipment |
| UL | Uplink |
| URLLC | Ultra Reliable Low Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may refer to either A or B, both A and B, at least one of A and B.

It should be noted that the term ‘TRP’ in the present disclosure may be replaced by ‘beam’ or ‘panel’. It should be noted that the term ‘overlap’ may refer to time domain overlapping.

Examples of some selected terms in the present disclosure are provided as follows.

Antenna Panel: It may be assumed that an antenna panel is an operational unit for controlling a transmit spatial filter/beam. An antenna panel is typically consisted of a plurality of antenna elements. A beam can be formed by an antenna panel and in order to form two beams simultaneously, two antenna panels are needed. Such simultaneous beamforming from multiple antenna panels is subject to the UE capability. A similar definition for “antenna panel” may be possible by applying spatial receiving filtering characteristics.

BWP: A subset of the total cell bandwidth of a cell is referred to as a BWP, and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. For the SCell(s), the initial BWP is the BWP configured for the UE to first operate at the SCell activation. The UE may be configured with a first active uplink BWP, for example, by a firstActiveUplinkBWP IE. If the first active uplink BWP is configured for an SpCell, the firstActiveUplinkBWP IE field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.

TCI state: A TCI state may contain parameters for configuring a QCL relationship between one or two reference signals and a target reference signal set. For example, a target reference signal set may be the DM-RS ports of the PDSCH, PDCCH, PUCCH or PUSCH. The one or two reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides an UL beam information which may provide the information for a relationship between an UL transmission and a DL (or a UL) reference signals (e.g., CSI-RS, SSB, SRS, PTRS).

Panel: The UE panel information may be derived from the TCI state/UL beam indication information or from the network signaling.

Beam: The term “beam” here may be replaced with spatial filter. For example, when a UE reports a preferred gNB TX beam, the UE is essentially selecting a spatial filter used by the gNB. The term “beam information” may be used to provide information about which beam/spatial filter has been used/selected.

Multi-TRP: Multi-TRP is a feature that enables a gNB to communicate with a UE using more than one TRP, for example, to ensure reliability. Moreover, same data stream(s) from multiple TRPs may be transmitted/received at least with an ideal backhaul, and different data streams from multiple TRPs may be transmitted/received with both ideal and non-ideal backhauls. An ideal backhaul may allow single DCI to be transmitted via a PDCCH from one TRP to schedule data transmission (or information) to/from multiple TRPs (may also be referred to as single-DCI based multi-TRP/panel transmission). On the other hand, a non-ideal backhaul may require multiple DCIs to be carried in the PDCCH(s) to schedule data transmission (or information) corresponding to each TRP (may also be referred to as multi-DCI based multi-TRP/panel transmission). To enhance reliability for the system, at least one multi-TRP scheme may be applied to at least one channel/reference signal, for example, a multi-TRP based PDSCH operation, a multi-TRP based PDCCH operation, a multi-TRP based PUCCH operation, and/or a multi-TRP based PUSCH operation.

TDM based PDCCH repetition: For example, two PDCCHs may be linked together for the repetition of the same DCI format, the same DCI payload, the same number of CCEs, and/or the same number of candidates for each AL. The two PDCCHs may be in two search spaces associated with two CORESETs.

TDM based PDSCH repetition: PDSCH repetition refers to multiple PDSCHs that have the same TB and are associated with different TRPs. Slot-based or inter-slot based PDSCH repetition corresponds to scheduling each repetitive PDSCH in individual slots. Non-slot-based or intra-slot based PDSCH repetition corresponds to scheduling multiple repetitive PDSCHs within the same slot.

TDM based PUCCH repetition: PUCCH repetition refers to multiple PUCCHs (e.g., in response to corresponding PDSCH) with the same UCI content but corresponding to different beams. There are two types of PUCCH repetitions: inter-slot based PUCCH repetition and intra-slot based PUCCH repetition, which are categorized according to their timing and relate to all PUCCH formats. Inter-slot based PUCCH transmission corresponds to transmitting each repetitive PUCCH in individual slots. Intra-slot based PUCCH transmission corresponds to transmitting each repetitive PUCCH within the same slot.

TDM based PUSCH repetition: PUSCH repetition refers to multiple PUSCHs with the same TB but corresponding to different TRPs. Slot-based or inter-slot based PUSCH repetition corresponds to scheduling each repetitive PUSCH in an individual slot. Non-slot-based or intra-slot based PUSCH repetition corresponds to scheduling multiple repetitive PUSCHs within the same slot.

FDM based (PDSCH) repetition: Multiple channels (e.g., PDSCHs) carrying the same TB but corresponding to two TCI states. These channels (e.g., PDSCHs) are allocated to non-overlapping frequency resources within a slot.

Multi-DCI based (PDSCH) scheme: Two PDCCHs from separate search spaces associated with different CORESET pool indexes that schedule the corresponding data streams/channels (e.g., PDSCHs).

Single Frequency Network (SFN) based PDCCH scheme: a CORESET corresponding to single frequency is associated with two different beams.

SFN based PDSCH scheme: a PDSCH corresponding to single frequency is associated with two different beams.

### TCI State:

A UE may be configured with a list including up to M TCI state configurations, where each TCI state may contain parameters for configuring at least one QCL relationship between one or more (e.g., two) downlink reference signals and the DM-RS ports of the PDSCH, the DM-RS port of PDCCH, or the CSI-RS port(s) of a CSI-RS resource. On the other hand, UL TCI states may include parameters for providing one or two RS (e.g., SSB, CSI-RS, SRS) for determining UL transmission spatial filter for UL transmissions (e.g., CG PUSCH, DG PUSCH, SRS). The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

Furthermore, a UE may be configured with a TCI state configuration that contains parameters for determining a UL TX spatial filter for the UL transmissions. More specifically, when signals transmitted from different antenna ports share channels with similar properties, the antenna ports are said to be QCL signals. Basically, the QCL concept is introduced to help the UE with a precise channel estimation, frequency offset error estimation, and synchronization procedures. It should be noted that there are three types of TCI states for the unified TCI framework, including UL TCI states, DL TCI states, and joint TCI states.

Unified TCI framework: To facilitate more efficient (lower latency and overhead) DL/UL beam management to support a larger number of configured TCI states, a unified TCI framework for beam indication may result in some benefits of low complexity and simplified controlling mechanisms. More specifically, through the unified indication, the DL or UL channels/signals may share the same indicated TCI state to reduce the signaling overhead, and different channels and/or reference signals may share similar channel properties. The unified indication may be used to indicate a common TCI state for the DL channels (e.g., including a PDCCH, PDSCH, and/or DL reference signal), a common TCI state for the UL channels (e.g., including a PUCCH, PUSCH, and/or UL reference signal), and/or a common TCI state for both DL and UL channels. The unified indication for a common TCI state for the DL channels may be referred to as a “DL only TCI state”, a “DL TCI state” or a “DL only”. The unified indication for a common TCI state for the UL channels may be referred to as a “UL only TCI state”, a “UL TCI state” or a “UL only”. The unified indication for a common TCI state for both DL and UL channels may be referred to as a “joint TCI state mode”, a “joint TCI state” or a “joint indication”. The “DL only TCI state” and “UL only TCI state” may also be referred to as a “separate TCI state mode” or a “separate TCI state”, as opposed to the “joint TCI state mode” or “joint TCI state”.

Inter-cell beam management: For a UE, the ability to receive and transmit data to and from different TRPs associated with different cells, including the serving cell and non-serving cells, may offer advantages not only in terms of signaling maintenance but also in enhancing reliability. The inter-cell beam management may be indicated to the UE via a configuration, RRC signaling, a DCI, or a MAC CE. Furthermore, whether to support inter-cell beam management may be reported by a UE capability. To inform the UE which cell the TRP is associated with, an indicator with an additional PCI index in a TCI configuration may be used to indicate that a TCI state/QCL information refers to an additional PCI different from the PCI of the serving cell. It should be noted that the TCI configuration may refer to a DL TCI configuration (a list of TCI states for DL channels/RSs), UL TCI configuration (a list of TCI states for UL channels/RSs), unified TCI configuration (a list of TCI states for both DL and UL channels/RSs), and/or a list of TCI states associated with a PDSCH, CORESET, PDCCH, SSB, CSI-RS, UL power control, UL pathloss, PRACH, PUSCH, SRS, PUCCH, BWP, and/or serving cell configuration.

Inter-cell mobility: When a UE moves from the coverage area of one cell to another cell, a serving cell change needs to be performed due to the maintenance of connection and the quality of service between the serving cell and the UE. The main target of Layer 1/Layer 2 (L1/L2) based mobility is to reduce latency in mobility. Consequently, support of L1 beam management and L1 based measurement is needed to facilitate the scheduling efficiency. In detail, mobility latency may include the duration from when the UE receives the cell switch command to when the UE performs the first DL reception or transmission based on the indicated beam of the target cell. More specifically, the time that the UE processes the cell switch command (T_{cmd}+T_{processing,2}), the UE executes DL synchronization (T_{search}+T_{Δ}+T_{margin}), the UE executes UL synchronization (T_{IU}+T_{RAR}), and the UE performs the first DL reception or transmission after the random access response (RAR) are considered as handover interruption time, where T_{cmd} refers to the time for processing L1/L2 command, T_{processing,2} refers to the time for the UE processing after the cell switch command, T_{search} refers to the time required to search the target cell, T_{Δ} refers to the time for fine tracking and acquiring full timing information, T_{margin} refers to the time for SSB or CSI-RS post-processing, T_{IU} refers to interruption uncertainty in acquiring the first available PRACH occasion in the target cell, and T_{RAR} refers to the time for RAR delay.

Simultaneous TCI state update: When multiple cells share similar channel conditions or spatial relations, same TCI state may be applied to the multiple cells to improve the scheduling efficiency and reduce signaling overhead. The multiple cells may refer to serving cell(s), non-serving cell(s), neighboring cell(s), candidate cell(s), target cell(s), PCell(s), SpCell(s), PSCell(s), and/or SCell(s).

Unified TCI Framework upon mTRP Operation

One or more than one unified TCI states may be indicated through an RRC message, a MAC CE, and/or the DCI. For example, the RRC message may indicate whether the unified framework is enabled, and the MAC CE may further indicate where to apply the unified TCI framework. In addition, the DCI may also include information for the unified TCI states to explicitly indicate the TCI state to the UE. In particular, the information contained in the MAC CE may refer to a serving cell index, a DL BWP index, a UL BWP index, the number of TCI states included in each TCI codepoint, transmission direction, and/or a TCI state index. However, when the unified TCI framework is applied to multiple TRPs, there is no further information to link the specific TCI states to the specific TRPs. Therefore, implementations are disclosed regarding how to extend the unified TCI framework from single TRP (sTRP) to multiple TRP (mTRP).

On the other hand, when TCI configurations including a list of TCI states for indicating DL TCI, joint TCI, and/or UL TCI are absent in a BWP of a CC, the UE may apply the TCI configurations from a reference BWP of a reference CC. It should be noted that the term “CC” and “cell” may be used interchangeably in the present disclosure. This approach (e.g., providing the reference BWP or the reference CC) reduces signaling overhead since there is no need to configure applicable TCI states for each BWP. Moreover, the reference BWP and the reference CC may be configured to the UE through RRC signaling. In other words, the indicated TCI state may be applied to the channels/RSs in the reference BWP of the reference CC. If the indicated common beam from the unified TCI configuration is blocked, a performance reduction may occur. Therefore, applying the unified TCI framework to multiple TRP scenario may prevent the UE from suffering from the beam blockage issue. More specifically, multiple TRP may enhance the reliability of receiving data with repetition using different beams for each repetition by operating different schemes or receiving different data on the same physical resource using different beams for mitigating the issue caused from beam blocking, especially for the one common beam operation. Besides, each TRP from the multiple TRPs may be associated with the same cell or different cells in CA scenario, in DC scenario or inter-cell mobility scenario. That is, the first TRP may be associated with the first cell (e.g., serving cell, PCell, SpCell, PSCell, source cell) or the first PCI (e.g., a serving cell PCI, a PCI associated with the serving cell, a PCI associated with the target cell, a PCI associated with the source cell, a PCI associated with a PCell, a PCI associated with a SpCell, a PCI associated with a PSCell) and the second TRP may be associated with the second cell or the second PCI (e.g., a target cell, a secondary cell, a cell with an additional PCI different from that of the serving cell, an additional PCI different from that of the serving cell). It should be noted that the terms “first cell/first PCI” and “second cell/second PCI” are changeable. The terms do not imply the priority or the order of the mentioned cells. In addition, the first TRP and the second TRP may be associated with the same cell but correspond to different reference TCIs.

Implementations for handling the extension of the reference BWP of the reference CC upon intra-cell mTRP and inter-cell mTRP operation are disclosed.

### TRP/Panel Identification

In some implementations, different channels/resources/reference signals corresponding to the same TRP/panel may mean different channels/resources corresponding to the same SRI, SRS resource set, Transmission Precoding Matrix Indicator (TPMI), DL TCI state, UL TCI state, CORESETPoolIndex, CORESET, CORESET group, TCI configuration, power control parameter, spatial relation information, search space, search space group, CSI-RS resource configuration, reference signal indication, panel indication, and/or joint TCI state.
There may be no explicit indication on TRP information in some implementations, and a default beam may be determined based on a (pre-) configured/(pre-) determined rule.
The TCI configuration may include, but is not limited to, a unified TCI state type, a joint TCI state, a UL TCI state, and/or a DL TCI state in some implementations.
The TCI configuration may refer to the RRC parameters that are listed for adding or releasing the TCI states in some implementations.
The TCI configuration may correspond to any scheduling configuration, such as a PDSCH-Config, a PUSCH-Config, a PUCCH-Config, a PUCCH-ConfigurationList, and/or a PDCCH-Config in some implementations.
The TCI configuration may include any TCI information, such as a TCI state index, a QCL type, unified TCI framework triggering, and/or multi-TRP scheme.

In some implementations, different channels/resources/reference signals corresponding to the same TRP/panel may mean that the channels/resources/reference signals are using the same spatial domain filter/setting as for the reception of an SS/PBCH block. The UE may apply the same parameters for determining the same spatial domain filter for the different channels/resources/reference signals corresponding to the same TRP/panel. For example, the same parameters may be included in the TCI state.

In some implementations, different channels/resources/reference signals corresponding to the same TRP/panel may mean that the channels/resources/reference signals are associated with a QCL assumption providing the same reference signal.

In some implementations, different channels/resources/reference signals corresponding to the same TRP/panel may mean that the channels/resources/reference signals are using the same spatial domain filter/setting as for reception of a periodic/semi-persistent/aperiodic CSI-RS resource. The UE may apply the same parameters for determining the same spatial domain filter for the different channels/resources/reference signals corresponding to the same TRP/panel. For example, the same parameters may be included in the TCI state.

In some implementations, different channels/resources/reference signals corresponding to the same TRP/panel may mean that the channels/resources/reference signals are indicated to be applied to the same spatial TX/RX domain filter/setting to transmit/receive toward/from the corresponding TRP/panel.

In some implementations, different channels/resources/reference signals corresponding to the same TRP/panel may mean that the channels/resources/reference signals are using the same spatial domain filter/setting as for the transmission of an SRS. The SRS resource may be for one of the following purposes: beam management, codebook-based channel sounding, or non-codebook-based channel sounding. For example, the SRS resource may serve the purpose of beam management.

In some implementations, different channels/resources corresponding to the same TRP/panel may mean that the channels/resources/reference signals are using the same spatial domain filter/setting as for PDCCH receptions corresponding to the same CORESET ID or the same CORESET group.

In some implementations, different channels/resources corresponding to the same TRP/panel may mean that the channels/resources/reference signals are using the same spatial domain filter/setting as for PDCCH receptions of which the associated CORESET index(es) correspond to the same CORESET pool index.

In some implementations, different channels/resources corresponding to the same TRP/panel may mean that the channels/resources/reference signals are indicated to the same set of power control parameters. The power control parameters may include, but not limited to, pathloss RS, Transmit Power Control (TPC) command, P0 value, alpha value, and close loop index.

In some implementations, different channels/resources corresponding to the same TRP/panel may mean that the channels/resources/reference signals are associated with the same BFD RS set.

### Unified TCI Indication

In some implementations, the at least one unified indication may refer to a common DL beam indication, a common UL beam indication, and/or a joint DL/UL beam indication. Specifically, the beam indication may refer to a TRP/panel indication.

The common DL beam indication (or separate DL beam indication) may correspond to the same DL TCI state, the same information of QCL assumption, the same CORESET index, the same CORESET pool index, the same search space index, the same search space group index, the same group index, the same RS index, the same BFD RS index/set, and/or the same DLorJoint TCI state.

The common UL beam indication (or separate UL beam indication) may correspond to the same UL TCI state, the same SRS resource set, the same spatial relation information, the same power control set, the same CORESET index, the same CORESET pool index, the same search space index, the same search space group index, the same group index, the same RS index, and/or the same DLorJoint TCI state.

The joint DL/UL beam indication may correspond to the same group index, and/or same DLorJoint TCI state.

The unified indication may refer to a number of activated/configured TCI states. The activated/configured TCI states may correspond to a group specific to the unified TCI framework. The UE may receive the unified indication via an RRC message, a MAC CE and/or the DCI from the serving cell. The serving cell may refer to a PCell, PSCell, SpCell, SCell, and/or a cell with the PCI that is different from the PCell.

A reference unified TCI state may be used to provide the applicable TCI state in a case where TCI state is not present in a BWP of a serving cell from a reference BWP of a reference serving cell. It should be noted that the reference unified TCI state may be a DL TCI state, a UL TCI state, a joint TCI state, a list of DL TCI states, a list of UL TCI states, or a list of joint TCI states.

RRC Signaling for Unified TCI Framework Upon mTRP Operation
More than One Reference Unified TCI States Correspond to More than One BWPs and/or More than One CCs

In some implementations, more than one reference unified TCI states may correspond to more than one BWPs and/or more than one CCs.

In some implementations, the RRC signaling/message for indicating the more than one reference unified TCI states may refer to separate signaling/configuration/message or a single signaling/configuration/message.

In some implementations, a UE may receive a RRC signaling/message including the more than one reference unified TCI states.

In some implementations, a UE may receive a RRC signaling/message including a configuration for indicating the more than one BWPs and/or the more than one CCs.

In some implementations, the more than one CCs may refer to a PCell, SCells, and/or PSCells.

Table 1 illustrates a configuration for indicating the reference BWP and cell, according to an example implementation of the present disclosure. Table 2 illustrates another configuration for indicating the reference BWP and cell, according to another example implementation of the present disclosure. In some implementations, the more than one CCs may refer to the serving cell and the target cell as shown in Table 1 and/or Table 2.

The first cell and the first BWP may be indicated by the first ID in ServingCellAndBWP-Id-r18 IE. The first cell and the first BWP may be indicated by the first ID in ServingCellAndBWP-Id-r18 IE and correspond to the parameter first-servingcell-r18 and first-bwp-r18. The second cell and the second BWP may be indicated by the second ID in ServingCellAndBWP-Id-r18 IE and correspond to the parameter second-servingcell-r18 and second-bwp-r18. In addition, an additional PCI different from that of the serving cell in the configuration may correspond to a PCI index.

TABLE 1
BWP-UplinkDedicated ::= SEQUENCE {
...
ul-TCI-StateList-r17 CHOICE {
explicitlist SEQUENCE {
ul-TCI-ToAddModList-r17 SEQUENCE (SIZE (1..maxUL-TCI-r17))
OF TCI-UL-State-r17
OPTIONAL, -- Need N
ul-TCI-ToReleaseList-r17 SEQUENCE (SIZE (1..maxUL-TCI-r17))
OF TCI-UL-State-Id-r17
OPTIONAL -- Need N
},
unifiedTCI-StateRef-ToAddModList-r18
ServingCellAndBWP-Id-r18 SEQUENCE
(SIZE (1..maxServingCellAndBWP -r18)) OF
ServingCellAndBWP-Id-r18 OPTIONAL, -- Need
N
}
...
}

TABLE 2
- ServingCellAndBWP-Id
The IE ServingCellAndBWP-Id is used to indicate a serving cell and an
uplink or a downlink BWP.
ServingCellAndBWP-Id information element
-- ASN1START
-- TAG-SERVINGCELLANDBWP-ID-START
ServingCellAndBWP-Id-r18 ::= SEQUENCE {
first-servingcell-r18 ServCellIndex,
first-bwp-r18 BWP-Id
second-servingcell-r18 ServCellIndex,
second-bwp-r18 BWP-Id
}
-- TAG-SERVINGCELLANDBWP-ID-STOP
-- ASN1STOP

In some implementations, a UE may receive separate RRC parameters for indicating reference unified TCI states for the serving cell and the target cell respectively, e.g., unifiedTCI-StateRef-r18_servingcell and unifiedTCI-StateRef-r18_targetcell. The UE may apply the indicated reference unified TCI states for the serving cell for transmission/reception of channels/RSs in the serving cell. The UE may apply the indicated reference unified TCI states for the target cell for transmission/reception of channels/RSs in the target cell.

In some implementations, a UE may receive the reference unified TCI states corresponding to a serving cell and BWP-ID and an additional PCI index. Table 3 illustrates a configuration for indicating an additional cell as the reference cell, according to an example implementation of the present disclosure. The parameter additionalPCI-Id may refer to an index for indicating a cell that is different from the serving cell.

TABLE 3
BWP-UplinkDedicated ::= SEQUENCE {
...
ul-TCI-StateList-r17 CHOICE {
explicitlist SEQUENCE {
ul-TCI-ToAddModList-r17 SEQUENCE (SIZE (1..maxUL-TCI-r17))
OF TCI-UL-State-r17
OPTIONAL, -- Need N
ul-TCI-ToReleaseList-r17 SEQUENCE (SIZE (1..maxUL-TCI-r17))
OF TCI-UL-State-Id-r17
OPTIONAL -- Need N
},
unifiedTCI-StateRef-r17 ServingCellAndBWP-Id-r17
unifiedTCI-StateRef-r18 additionalPCI-Id
}
...
}

In some implementations, a UE may receive the reference unified TCI states per TRP. For example, a first reference unified TCI state may correspond to a first TRP index and a second reference unified TCI state may correspond to a second TRP index. Specifically, the first TRP index may be associated with the first BWP/CC and the second TRP index may be associated with the second BWP/CC. It should be noted that the TRP index may refer to a CORESETPoolIndex, an SRS resource set index, or an explicit TRP index.

In some implementations, a UE may receive the RRC signaling/message in an RRC reconfiguration message, e.g., after the UE completes the RRC (connection) setup procedure, when the UE performs handover to a target cell, when the UE performs L1/L2 inter-cell mobility, when the UE performs SN addition/modification/change procedure, and/or when the UE performs conditional PScell change/addition (CPC, CPA, CPAC) procedure, but not limited thereto.

The reference unified TCI states may correspond to a list of TCI states to be added or released in the configuration.

The more than one BWPs may correspond to a list of BWP indices.

The more than one CCs may correspond to a list of serving cell indices, PCI index for serving cell and/or PCI index for the cell different from the serving cell.

The more than one BWPs and the more than one CCs may be indicated in the same or different configuration.

The BWP index to which the unified TCI state is applied in different TCI configurations may be the same or different.

The serving cell index to which the unified TCI state is applied in different TCI configurations may be the same or different.

The BWP index corresponding to the serving cell and the target cell for the unified TCI state may be the same. More specifically, the same BWP index may be linked to the serving cell and the target cell.

The BWP index corresponding to the serving cell and the target cell may be different. More specifically, different BWP indices may be linked to the serving cell and the target cell, respectively.

The more than one BWPs may refer to a set of reference BWPs for a UE. The first BWP may refer to the first reference BWP of the first CC and the second BWP may refer to the second reference BWP of the second CC. The first BWP may refer to the first reference BWP of the first CC and the second BWP may refer to the first reference BWP of the second CC. The first BWP may refer to the first reference BWP of the first CC and the second BWP may refer to the second reference BWP of the first CC.

The RRC signaling/message may refer to PDSCH configuration, BWP-Downlink configuration, BWP-Downlink common configuration, BWP-Downlink dedicated configuration, BWP-Uplink configuration, BWP-Uplink common configuration, BWP-Uplink dedicated configuration, CORESET configuration, PDCCH configuration, Search Space configuration, PhysicalCellGroup configuration, PUCCH configuration, PUSCH-Configuration, ServingCellandBWP-Id configuration, ServingCell configuration, ServingCellConfigCommon, TCI state configuration, TCI-UL-State configuration, TRP/panel configuration, and/or Unified TCI framework configuration.

The RRC signaling/message may refer to at least one RRC parameter.

The RRC signaling/message may refer to an RRC parameter dedicated to multiple TRP.

The target cell may refer to a cell associated with an additional PCI different from that associated with the serving cell.

More than One Reference Unified TCI States Correspond to a Reference BWP of a Reference CC

In some implementations, more than one reference unified TCI states may correspond to a reference BWP of a reference CC.

In some implementations, a UE may receive a RRC signaling/message including the more than one reference unified TCI states.

In some implementations, a UE may receive a RRC signaling/message including a configuration for indicating the reference BWP and/or the reference CC.

In some implementations, a UE may receive the reference unified TCI states per TRP. For example, a first reference unified TCI state may correspond to a first TRP index and a second reference unified TCI state may correspond to a second TRP index. Specifically, the first TRP index and the second TRP index may be associated with the same BWP/CC.

In some implementations, a UE may receive the RRC signaling/message in an RRC reconfiguration message, e.g., after the UE completes the RRC (connection) setup procedure, when the UE performs handover to a target cell, when the UE performs L1/L2 inter-cell mobility, when the UE performs SN addition/modification/change procedure, when the UE performs conditional PScell change/addition (CPC, CPA, CPAC) procedure, but not limited thereto.

The reference unified TCI states may correspond to a list of TCI states to be added or released in the configuration. Specifically, the order of TCI states in the list of TCI states may correspond to the same order of the associated TRP. For example, the first TCI state in the list of TCI states may correspond to the first TRP, CORESETPoolIndex0 or the first SRS resource set. The second TCI state in the list of TCI states may correspond to the second TRP, CORESETPoolIndex1 or the second SRS resource set.

The reference BWP may refer to a BWP ID. The reference CC may refer to a serving cell index.

The reference CC may refer to a cell different from the serving cell and may refer to an additional PCI index.

The RRC signaling/message may refer to PDSCH configuration, BWP-Downlink configuration, BWP-Downlink common configuration, BWP-Downlink dedicated configuration, BWP-Uplink configuration, BWP-Uplink common configuration, BWP-Uplink dedicated configuration, CORESET configuration, PDCCH configuration, Search Space configuration, PhysicalCellGroup configuration, PUCCH configuration, PUSCH-Configuration, ServingCellandBWP-Id configuration, ServingCell configuration, ServingCellConfigCommon, TCI state configuration, TCI-UL-State configuration, TRP/panel configuration and/or Unified TCI framework configuration.

The RRC signaling/message may refer to at least one RRC parameter. Specifically, when the at least one RRC parameter is configured, more than one unified TCI states may be applied to the indicated serving cell and BWP. In other words, the RRC parameter may be used to indicate multiple TRP based reference unified TCI state. Table 4 illustrates a configuration for indicating a reference unified TCI state, according to an example implementation of the present disclosure.

TABLE 4

PDSCH-Config ::= SEQUENCE {
...
dl-OrJoint-TCIStateList-r18 CHOICE {
explicitlist SEQUENCE {
dl-orJoint-TCI-State-ToAddModList-r18 SEQUENCE (SIZE
(1..maxNrofTCI-States)) OF TCI-
State
OPTIONAL, -- Need N
dl-orJoint-TCI-State-ToReleaseList-r18 SEQUENCE (SIZE
(1..maxNrofTCI-States)) OF TCI-
StateId
OPTIONAL -- Need N
},
unifiedTCI-StateRef-r18 ServingCellAndBWP-Id-r18
}...
}

The RRC signaling/message may refer to an RRC parameter dedicated to multiple TRP based unified TCI framework.

Conditions for Applying the Reference Unified TCI States for mTRP

In some implementations, when at least one condition is satisfied, the UE may apply the reference unified TCI states as the applicable TCI states to more than one BWPs of more than one CC. Specifically, the BWP may refer to DL BWP or UL BWP and the reference unified TCI states may refer to DL TCI states, UL TCI states, and/or joint TCI states.

In some implementations, when at least one condition is satisfied, the UE may apply the reference unified TCI states as the applicable TCI states to a BWP of a CC. Specifically, the BWP may refer to DL BWP or UL BWP and the reference unified TCI states may refer to DL TCI states, UL TCI states, and/or joint TCI states.

In some implementations, the mentioned RRC signaling/message to the UE may refer to a single signaling/configuration/message or separate RRC signaling/configuration/message.

In some implementations, the at least one condition may be that a RRC signaling/message is absent, or the UE does not receive a RRC signaling/message for at least one DL/UL BWP configuration, channel specific configuration, and/or serving cell configuration. The RRC signaling/message may refer to RRC signaling/messages mentioned in the present disclosure.

In some implementations, the at least one condition may be that the UE receives a RRC signaling/message for indicating unified TCI framework with multiple TRP operation (e.g., separate or joint) applied to at least one channel, one RS, one BWP and/or one CC.

The multiple TRP may correspond to a serving cell, more than one serving cells, or a target cell.

The RRC signaling/message may refer to the signaling/message for indicating at least one DL TCI state for at least one active DL BWP, PDSCH, PDCCH, CORESET, CSI-RS, DMRS, a serving cell, and/or a target cell.

The RRC signaling/message may refer to the signaling/message for indicating at least one UL TCI state for at least one active UL BWP, PUCCH, PUSCH, SRS, a serving cell, and/or a target cell.

The RRC signaling/message may refer to the signaling/message for indicating at least one joint TCI state for at least one active DL BWP, one active UL BWP, PDSCH, PDCCH, CORESET, CSI-RS, DMRS, PUCCH, PUSCH, a serving cell, and/or a target cell.

The RRC signaling/message may refer to the signaling/message for indicating at least one TCI state for at least one TRP/panel/SRS resource set/SRS resource/CORESET group (e.g., CORESETPoolIndex0 or CORESETPoolIndex1)/CORESET.

If one of TCI states corresponding to a TRP/panel/SRS resource set/SRS resource/CORESET group (e.g., CORESETPoolIndex0 or CORESETPoolIndex1)/CORESET is absent, the reference unified TCI state may be applied.

The reference unified TCI state corresponding to each TRP/panel/CORESETPoolIndex/SRS resource set may be applied to the UE regardless of whether one of the applicable DL/UL/joint TCI states is indicated. More specifically, if a DL/UL/joint TCI state corresponding to a first TRP/panel/CORESETPoolIndex/SRS resource set in a first BWP is absent but a DL/UL/joint TCI state corresponding to a second TRP/panel/CORESETPoolIndex/SRS resource set in a second BWP is present, the reference unified TCI state may be applied to the first TRP/panel/CORESETPoolIndex/SRS resource set and the second TRP/panel/CORESETPoolIndex/SRS resource set in the first BWP and the second BWP.

The reference unified TCI state may be applied per TRP/panel/CORESETPoolIndex/SRS resource set to the UE based on which DL/UL/joint TCI state is absent. More specifically, if a DL/UL/joint TCI state corresponding to a first TRP/panel/CORESETPoolIndex/SRS resource set in a first BWP is absent but a DL/UL/joint TCI state corresponding to a second TRP/panel/CORESETPoolIndex/SRS resource set in a second BWP is present, the reference unified TCI state may be applied to the first TRP/panel/CORESETPoolIndex/SRS resource set in the first BWP.

Procedure for Applying Reference Unified TCI States for mTRP

In some implementations, a UE may receive a RRC signaling/message that indicates a first reference BWP of a first reference CC and a second reference BWP of a second reference CC when the at least one unified TCI state for an active DL BWP of a CC is absent. Afterwards, the UE may receive a first PDCCH/PDSCH/DL RS in the active DL BWP of the CC using a first unified TCI state corresponding to the first reference BWP of the first CC and a second PDCCH/PDSCH/DL reference signal in the active DL BWP of the CC using a second unified TCI state corresponding to the second reference BWP of the second CC.

In some implementations, a UE may receive a RRC signaling/message that indicates a first reference BWP of a first reference CC and a second reference BWP of a second reference CC when the at least one unified TCI state for an active UL BWP of a CC is absent. Afterwards, the UE may transmit a first PUCCH/PUSCH/UL RS in the active UL BWP of the CC using a first unified TCI state corresponding to the first reference BWP of the first CC and a second PUCCH/PUSCH/UL reference signal in the active UL BWP of the CC using a second unified TCI state corresponding to the second reference BWP of the second CC.

In some implementations, a UE may receive a RRC signaling/message that indicates a reference BWP of a reference CC with a first activated unified TCI state and a second activated unified TCI state when the at least one unified TCI state used for indicating the first activated unified TCI state or the second activated unified TCI state for an active DL BWP of a CC is absent. Afterwards, the UE may transmit a first PDCCH/PDSCH/DL RS in the active DL BWP of the CC using the first activated unified TCI state and a second PUCCH/PUSCH/UL reference signal in the active DL BWP of the CC using the second activated unified TCI state.

In some implementations, a UE may receive a RRC signaling/message that indicates a reference BWP of a reference CC with a first activated unified TCI state and a second activated unified TCI state when the at least one unified TCI state used for indicating the first activated unified TCI state or the second activated unified TCI state for an active UL BWP of a CC is absent. Afterwards, and the UE may transmit a first PUCCH/PUSCH/UL RS in the active UL BWP of the CC using the first activated unified TCI state and a second PUCCH/PUSCH/UL reference signal in the active UL BWP of the CC using the second activated unified TCI state.

In some implementations, at least one unified TCI state may refer to at least one list of unified TCI states, at least one TCI state included in the list of unified TCI states, at least one TCI state of the TCI states indicated to a CORESET group, and/or at least one reference unified TCI state.

In some implementations, a UE may receive a RRC signaling/message that indicates a first reference BWP of a first reference CC and a second reference BWP of a second reference CC when the UE is configured with the UL/DL BWP configuration by the serving cell and/or the target cell.

In some implementations, a UE may receive a RRC signaling/message that indicates a reference BWP of a reference CC with a first activated unified TCI state and a second activated unified TCI state when the UE is configured with the UL/DL BWP configuration by the serving cell and/or the target cell.

In some implementations, the RRC signaling/message may further include TCI configurations corresponding to the reference BWPs of the reference CC.

In some implementations, the RRC signaling may further include multiple TRP indication.

In some implementations, the RRC signaling/message may further include the unified TCI state indication, such as a flag for indicating whether to apply the unified TCI state.

In some implementations, each received DL channel/RS may correspond to different reference unified TCI states.

In some implementations, all received DL channels/RS may correspond to the same reference unified TCI state.

In some implementations, all received DL channels/RS from a first TRP (or a serving cell) may correspond to a first reference unified TCI state, while all received DL channel/RS from a second TRP (or a target cell) may correspond to a second reference unified TCI state.

In some implementations, each transmitted UL channel/RS may correspond to different reference unified TCI states.

In some implementations, all transmitted UL channels/RS may correspond to the same reference unified TCI state.

In some implementations, all transmitted UL channels/RS to a first TRP (or a serving cell) may correspond to a first reference unified TCI state, while all transmitted UL channels/RS to a second TRP (or a target cell) may correspond to a second reference unified TCI state.

In some implementations, the first reference BWP/CC or the second reference BWP/CC serves as an illustrative example for more than one BWPs/CCs. It should be noted that the disclosed implementations are not limited to only two reference BWPs/CCs for the UE.

In some implementations, the first activated unified TCI state or the second activated unified TCI state serves as an illustrative example for more than one TCI states (or TRPs). It should be noted that the disclosed implementations are not limited to only two TCI states (or TRPs) for the UE.

The number of supported reference BWPs/CCs may be reported as a UE capability. For example, when the UE receives the UE Capability Enquiry message from the serving cell, the UE may transmit the UE Capability Information message including the number of supported reference BWPs/CCs to the serving cell.

The number of activated unified TCI states may be reported as a UE capability. For example, when the UE receives the UE Capability Enquiry message from the serving cell, the UE may transmit the UE Capability Information message including the number of activated unified TCI states to the serving cell.

The number of activated unified TCI states and the number of reference BWPs/CCs may be the same or different.

### Simultaneous TCI Update on Unified TCI Framework

MIMO is one of the key technologies in NR systems and is successful in commercial deployment. Also, it is important to identify and specify necessary enhancements for uplink MIMO, while necessary enhancements on downlink MIMO that facilitate the use of large antenna array, not only for FR1 but also for FR2, would still need to be introduced to fulfil the request for evolution of NR deployments. Furthermore, mTRP has been introduced to enhance the massive MIMO, and mTRP operation may improve the reliability, coverage, and capacity performance through flexible deployment scenarios. During the mTRP operation, the base station may communicate with the UE through the mTRP.

One or more than one unified TCI states may be indicated through an RRC message, a MAC CE, and/or the DCI. For example, the RRC message may indicate whether the unified framework is enabled, and the MAC CE may further indicate where to apply the unified TCI framework, and then the DCI may be used to dynamically indicate the unified TCI framework operation. Thus, some information may be contained in the RRC signaling, MAC CE and/or DCI to support unified TCI framework for single TRP and unified TCI framework for multi-TRP, where the information may refer to serving cell index, PCI, AdditionalPCIIndex, DL BWP index, UL BWP index, the number of TCI states included in each TCI codepoint, target channels, transmission direction (UL or DL), and/or one or more than one TCI state index (including DL TCI, UL TCI, and joint TCI).

In one way, the indicated TCI state(s) may be applied to a set of BWPs/CCs for signaling overhead reduction since there is no need to configure applicable TCI states for each BWP/CC. In other words, when multiple BWPs/CCs share similar channel conditions, doppler shift, doppler spread, average delay, delay spread, source signaling location, or beam direction, same set of TCI states may be simultaneously indicated/updated to all CCs in the same CC list, and hence some signaling from gNB may be used to inform the specific details regarding how multiple BWPs/CCs share the applicable TCI states information together. Besides, the UE may apply the indicated TCI state(s) to one or to a set of CCs/DL BWPs/UL BWPs with or without receiving the unified TCI framework indication. Moreover, if the number of the indicated TCI states from gNB to the UE is more than one, mTRP operation may be assumed. The benefits of applying mTRP to unified TCI framework may include preventing the beam blockage issue, especially for the case of applying a common beam for multiple channels, since mTRP may enhance the reliability of receiving data with repetition using different beams for each repetition by operating different schemes or enhance the throughput by receiving different data on the same physical resource from different TRPs using different beams. However, if the indicated TCI states are applied to DL channels and UL channels simultaneously, the signaling for the indication for updating TCI states for mTRP based unified TCI framework may be needed.

On the other hand, each TRP from multiple TRPs on unified TCI framework may be associated with the same cell or different cells in CA scenario, in DC scenario, in inter-cell beam management (ICBM) scenario or in inter-cell mobility scenario. To be more specific, one of operations for ICBM and inter-cell mobility may mean that a first TRP may be associated with a first cell (e.g., serving cell, PCell, SpCell, PSCell, source cell) or a first PCI (e.g., a PCI associated with the serving cell, a PCI associated with the target cell, a PCI associated with the source cell, a PCI associated with a PCell, a PCI associated with a SpCell, a PCI associated with a PSCell) and a second TRP may be associated with a second cell or a second PCI (e.g., target cell, secondary cell, a cell with an additional PCI different from that of the serving cell, an additional PCI different from that of the serving cell). It should be noted that the first cell/the first PCI and the second cell/the second PCI are changeable and may refer to intra-frequency scenario or inter-frequency scenario, where the ‘first’ and the ‘second’ mentioned here do not imply the priority or the order of the mentioned cells. In addition, the first TRP and the second TRP may be associated with the same cell but correspond to different TCI states.

### Potential Scenarios

It should be noted that two CCs in following implementation serve merely as illustrative examples. In some implementations, more than two CCs may be configured. Therefore, updating TCI states simultaneously for multiple CCs in a CC list may apply to the scenarios listed below, but not limited thereto:

CC #1 and CC #2 are in the same CC list and different number of TCI states (TRPs) may be indicated/activated to each CC in the same CC list. For example, CC #1 may correspond to sTRP and CC #2 may correspond to mTRP; TCI #1 may be indicated to CC #1 and CC #2; TCI #2 may be indicated to CC #2.

TCI #1 may refer to a DL TCI state; TCI #2 may refer to a UL TCI state.

TCI #1 may refer to a UL TCI state; TCI #2 may refer to a DL TCI state.

TCI #1 may refer to a DL TCI state; TCI #2 may refer to a joint TCI state.

TCI #1 may refer to a joint TCI state; TCI #2 may refer to a DL TCI state.

TCI #1 may refer to a UL TCI state; TCI #2 may refer to a joint TCI state.

TCI #1 may refer to a joint TCI state; TCI #2 may refer to a UL TCI state.

TCI #1 may refer to a first joint TCI; TCI #2 may refer to a second joint TCI. The first joint TCI may correspond to a first TRP and the second TCI may correspond to a second TRP.

CC #1 and CC #2 are in different CC lists and each list may correspond to different number of TCI states. For example, CC #1 in CC list #1 may apply sTRP, and CC #2 in CC list #2 may apply mTRP. The same TCI state or different TCI states may be indicated to each CC in different CC list.

TCI #1 may be indicated to CC #1 in CC list #1; TCI #2 and TCI #3 may be indicated to CC #2 in CC list #2, where TCI #1, TCI #2, and TCI #3 may correspond to the same TCI ID or different TCI ID.

The combinations of TCI #1, TCI #2, and TCI #3 may refer to {DL TCI state, DL TCI state, DL TCI state}.

The combinations of TCI #1, TCI #2, and TCI #3 may refer to {DL TCI state, DL TCI state, UL TCI state}, where the order of corresponding TCI states may be arbitrarily changed.

The combinations of TCI #1, TCI #2, and TCI #3 may refer to {DL TCI state, UL TCI state, UL TCI state}, where the order of corresponding TCI states may be arbitrarily changed.

The combinations of TCI #1, TCI #2, and TCI #3 may refer to {UL TCI state, UL TCI state, UL TCI state}.

The combinations of TCI #1, TCI #2, and TCI #3 may refer to {DL TCI state, DL TCI state, joint TCI state}, where the order of corresponding TCI states may be arbitrarily changed.

The combinations of TCI #1, TCI #2, and TCI #3 may refer to {UL TCI state, UL TCI state, joint TCI state}, where the order of corresponding TCI states may be arbitrarily changed.

The combinations of TCI #1, TCI #2, and TCI #3 may refer to {DL TCI state, UL TCI state, joint TCI state}, where the order of corresponding TCI states may be arbitrarily changed.

The combinations of TCI #1, TCI #2, and TCI #3 may refer to {DL TCI state, joint TCI state, joint TCI state}, where the order of corresponding TCI states may be arbitrarily changed.

The combinations of TCI #1, TCI #2, and TCI #3 may refer to {UL TCI state, joint TCI state, joint TCI state}, where the order of corresponding TCI states may be arbitrarily changed.

The combinations of TCI #1, TCI #2, and TCI #3 may refer to {joint TCI state, joint TCI state, joint TCI state}, where the order of corresponding TCI states may be arbitrarily changed.

CC #1 and CC #2 are in different CC lists and each list may correspond to the same number of TCI states. CC #1 in CC list #1 may apply mTRP, and CC #2 in CC list #2 may apply mTRP as well. CC #1 in CC list #1 may apply sTRP, and CC #2 in CC list #2 may apply sTRP as well. In addition, the same TCI state or different TCI states may be indicated to each CC in different CC list.

TCI #1 and TCI #2 may be indicated to CC #1; TCI #3 and TCI #4 may be indicated to CC #2. TCI #1 may be indicated to CC #1; TCI #2 may be indicated to CC #2.

The combinations of TCI #1, TCI #2, TCI #3, and TCI #4 may refer to {DL TCI state, DL TCI state, DL TCI state, DL TCI state}.

The combinations of TCI #1, TCI #2, TCI #3, and TCI #4 may refer to {DL TCI state, UL TCI state, DL TCI state, DL TCI state}.

The combinations of TCI #1, TCI #2, TCI #3, and TCI #4 may refer to {DL TCI state, DL TCI state, UL TCI state, UL TCI state}.

The combinations of TCI #1, TCI #2, TCI #3, and TCI #4 may refer to {DL TCI state, UL TCI state, UL TCI state, UL TCI state}.

The combinations of TCI #1, TCI #2, TCI #3, and TCI #4 may refer to {UL TCI state, UL TCI state, UL TCI state, UL TCI state}.

The combinations of TCI #1, TCI #2, TCI #3, and TCI #4 may refer to {joint TCI state, DL TCI state, DL TCI state, DL TCI state}.

The combinations of TCI #1, TCI #2, TCI #3, and TCI #4 may refer to {joint TCI state, DL TCI state, DL TCI state, UL TCI state}.

The combinations of TCI #1, TCI #2, TCI #3, and TCI #4 may refer to {joint TCI state, DL TCI state, UL TCI state, UL TCI state}.

The combinations of TCI #1, TCI #2, TCI #3, and TCI #4 may refer to {joint TCI state, UL TCI state, UL TCI state, UL TCI state}.

The combinations of TCI #1, TCI #2, TCI #3, and TCI #4 may refer to {joint TCI state, joint TCI state, DL TCI state, UL TCI state}.

The combinations of TCI #1, TCI #2, TCI #3, and TCI #4 may refer to {joint TCI state, joint TCI state, DL TCI state, DL TCI state}.

The combinations of TCI #1, TCI #2, TCI #3, and TCI #4 may refer to {joint TCI state, joint TCI state, UL TCI state, UL TCI state}.

The combinations of TCI #1, TCI #2, TCI #3, and TCI #4 may refer to {joint TCI state, joint TCI state, joint TCI state, DL TCI state}.

The combinations of TCI #1, TCI #2, TCI #3, and TCI #4 may refer to {joint TCI state, joint TCI state, joint TCI state, UL TCI state}.

The combinations of TCI #1, TCI #2, TCI #3, and TCI #4 may refer to {joint TCI state, joint TCI state, joint TCI state, joint TCI state}.

Each CC may be in the same or different cell group or CC list.

CC #1 may be in CC list #1; CC #1 may be in CC list #2 and CC #2 may be in CC list #2.

CC #1 may be in CC list #1; CC #2 may be in CC list #1 and CC #1 may be in CC list #2.

CC #1 may be in CC list #1; CC #2 may be in CC list #2.

CC #1 and CC #2 may correspond to one MAC entity or different MAC entities.

DL channels and/or UL channels in CC #1 may apply sTRP scheme; DL channels and/or UL channels in CC #2 may apply mTRP scheme.

Implementations for handling simultaneous TCI update for multiple BWPs/CCs upon different scenarios on unified TCI framework are disclosed.

### RRC Signaling for Simultaneous TCI Update on Unified TCI Framework

In some implementations, RRC signaling for simultaneous TCI states update for multiple CCs may be based on the number of TRPs. More specifically, a first set of CCs may correspond to a first number of TRP, and a second set of CCs may correspond to a second number of TRPs.

In some implementations, the CC index in the first set and the CC index in the second set may be the same or different.

In some implementations, the first number of TRP may refer to one, and the second number of TRPs may refer to a value more than one (e.g., two or four).

In some implementations, RRC signalling for simultaneous TCI states update for multiple CCs may be based on TRP group(s). More specifically, a first set of CCs may correspond to a first TRP group, and a second set of CCs may correspond to a second TRP group. It should be noted that the number of TRPs configured in one TRP group may be any positive integers (e.g., 1, 2, 3, 4, etc.). In addition, the TRP group may correspond to CORESETPoolIndex. For example, the first TRP group may be configured with CORESETPoolIndex 0 and the second TRP group may be configured with CORESETPoolIndex 1.

In some implementations, the CC index in the first TRP group may be the same as or different from the CC index in the second group.

In some implementations, the number of TRPs configured to the first TRP group may be one, and the number of TRPs configured to the second TRP group may be larger than one (e.g., two or four).

In some implementations, RRC signalling for simultaneous TCI states update for multiple CCs may be based on SRS resource set(s). More specifically, a first set of CCs may correspond to a first SRS resource set, and a second set of CCs may correspond to a second SRS resource set. It should be noted that each SRS resource set may be configured to one or more PUSCH transmission(s).

In some implementations, the CC index in the first SRS resource set may be the same as or different from the CC index in the second SRS resource set.

In some implementations, the number of TRPs associated with the first SRS resource set may be one, and the number of TRPs associated with the second SRS resource set may be larger than one (e.g., two).

In some implementations, RRC signaling for simultaneous TCI states update for multiple CCs may be based on different transmission mode (e.g., sTRP, mTRP, CJT, or SFN). More specifically, a first set of CCs may correspond to the sTRP operation, and a second set of CCs may correspond to the mTRP operation.

In some implementations, the CC index in the sTRP operation may be the same as the partial CC index in the mTRP operation.

In some implementations, the CC index in the sTRP operation may be the same as or different from the CC index in the mTRP operation.

In some implementations, the number of TRPs configured to the first TRP group may be one, and the number of TRPs configured to the second TRP group may be larger than one (e.g., two or four).

In some implementations, RRC signaling for simultaneous TCI states update for multiple CCs may refer to an RRC configuration or an RRC parameter. The RRC configuration may be configured per BWP, per cell, per TRP, per UE, per set of BWPs, per set of cells, per set of TRPs, per set of UEs, and/or per cell group.

In some implementations, the RRC signaling may be included in a TCI configuration. For example, the TCI configuration may refer to TCI-State, TCI-UL-State, or unified TCI-state.

In some implementations, the RRC signaling may be included in a BWP configuration. For example, the BWP configuration may refer to BWP, BWP-Downlink, BWP-DownlinkCommon, BWP-DownlinkDedicated, BWP-Uplink, BWP-UplinkCommon and/or BWP-UplinkDedicated.

In some implementations, the RRC signaling may be included in a serving cell configuration. For example, the serving cell configuration may refer to ServingCellConfig, ServingCellConfigCommon, PDCCH-ServingCellConfig, PDSCH-ServingCellConfig, and/or PUSCH-ServingCellConfig.

In some implementations, the RRC signaling may be included in a cell group configuration. For example, the cell group configuration may refer to PhysicalCellGroupConfig, and/or CellGroupConfig.

In some implementations, the RRC signaling may be included in a channel configuration. For example, the channel configuration may refer to PDCCH-Config, PDCCH-ConfigCommon, PDSCH-Config, PDSCH-ConfigCommon, PUSCH-Config, PUSCH-ConfigCommon, PUCCH-Config, and/or PUCCH-ConfigCommon.

In some implementations, the RRC signaling may be associated with CORESETPoolIndex.

In some implementations, the RRC signaling for simultaneous TCI states update for multiple CCs may be indicated to the same or different RSs/channels.

In some implementations, when one or more than one TCI state is indicated, the indicated TCI state(s) may be applied to one or more than one RSs/channels for a set of CCs.

The RRC signaling may indicate TCI #1 to PDSCH in CC #1 and CC #2 and indicate TCI #1 to PUSCH in CC #2 and CC #3. In other words, the indicated TCI states may be separately applied to different channels for a set of CCs. Moreover, the indicated TCI states may be applied to channels in the same CC or different CCs.

The RRC signaling may indicate TCI #1 to PDSCH and PUCCH in CC #1 and CC #2 and indicate TCI #2 and TCI #3 to PUSCH in CC #1 and CC #2. In other words, in the same set of CCs, the indicated TCI states may be separately applied to different channels.

The RRC signaling may indicate TCI #1 to PDCCH and PDSCH in CC #1 and CC #2 and indicate TCI #2 and TCI #3 to PUCCH and PUSCH in CC #1 and CC #2. In other words, in the same set of CCs, the indicated TCI states may be separately applied to DL and UL channels.

The RRC signaling may indicate TCI #1 referring to CSI-RS in CC #1 and CC #2 and indicate TCI #1 referring to DMRS in CC #2 and CC #3. In other words, the indicated TCI states may be separately applied to different RS types for a set of CCs. Moreover, the indicated TCI states may be applied to RSs in the same CC or different CCs.

The RRC signaling may indicate TCI #1 referring to CSI-RS and DMRS in CC #1 and CC #2 and indicate TCI #2 and TCI #3 referring to SRS in CC #1 and CC #2. In other words, in the same set of CCs, the indicated TCI states may be separately applied to different RS types.

The RRC signaling may indicate TCI #1 to CSI-RS and SSB in CC #1 and CC #2 and indicate TCI #2 and TCI #3 referring to SRS and DMRS in CC #1 and CC #2. In other words, in the same set of CCs, the indicated TCI states may be separately applied to DL and UL RSs.

In some implementations, when different numbers of TCI states are indicated to different channels for a set of CCs, TCI update may be channel specific for the set of CCs. CCs corresponding to same number of TCI states may correspond to the same group. Channels corresponding to/configured with same number of TCI states may correspond to the same group.

A first group may include CC #1 and CC #2, and a second group may include CC #3 and CC #4. Furthermore, the first group may correspond to a single TCI state and the second group may correspond to more than one TCI states.

A first group may include CC #1 and CC #2, and a second group may include CC #1 and CC #3. Furthermore, the first group may correspond to a single TCI state and the second group may correspond to more than one TCI states. The first group may correspond to sTRP operation, and the second group may correspond to mTRP/CJT/SFN operation(s).

A first group may include at least one DL RS/channel in CC #1, and a second group may include at least one UL RS/channel in CC #1. Furthermore, the first group may correspond to a single TCI state and the second group may correspond to more than one TCI states.

A first group may include at least one DL RS/channel in CC #1, and a second group may include at least one UL RS/channel in CC #2. Furthermore, the first group may correspond to a single TCI state and the second group may correspond to more than one TCI states.

The association between a channel and a TCI state may be configured by IE/RRC parameter or RRC configuration.

The first group and the second group may correspond to the same or different cell group.

In some implementations, RRC signaling for TCI state indication for different transmission direction (e.g., joint/DL TCI and UL TCI) may correspond to the same or different TCI state configuration.

In some implementations, the TCI state configuration may correspond to a set of CCs.

In some implementations, joint/DL TCI state and UL TCI state may correspond to a common group of TCI state ID. More specifically, joint/DL TCI state ID and UL TCI state ID may share the same index pool. For example, TCI state ID for simultaneous TCI update for multiple CCs may refer to TCI-state-id, TCI-UL-state-id, or unified-TCI-state-mTRP.

Joint TCI, DL TCI, and UL TCI may correspond to a common TCI state, where the common TCI state may apply to DL receptions and/or UL transmissions.

In some implementations, joint/DL TCI state ID and UL TCI state ID may correspond to the same maximum number of TCI states. For example, the value of maxNrofTCI-States, maxNrofTCI-StatesPDCCH, and maxUL-TCI-r17 (or other parameters representing the maximum number of TCI states) may be the same (e.g., 64, 128, 256).

In some implementations, the indicated joint/DL TCI state ID and UL TCI state ID may correspond to the same value. For example, TCI state ID equals to 1 may apply to DL receptions and/or UL transmissions. In other words, the UE may be indicated a joint/DL TCI state and a UL TCI state for DL receptions and/or UL transmissions. The indicated joint/DL TCI state and a UL TCI state may be configured with the same value. For example, the index corresponding to the joint/DL TCI state ID and UL TCI state ID may be configured with the same value.

In some implementations, RRC signaling for simultaneous TCI states update for multiple CCs on unified TCI framework for mTRP scheme may correspond to a dedicated TCI state configuration.

In some implementations, a specific RRC parameter/configuration may be used to indicate simultaneous TCI update for multiple CCs, such as TCI-State-Config-R18.

In some implementations, single TRP based CC list and mTRP based CC list may correspond to separate RRC signaling, where single TRP based CC list may refer to a set of CCs with single indicated TCI state and mTRP based CC list may refer to a set of CCs with more than one indicated TCI states.

Implementations regarding RRC signaling for configuring multiple CCs may include:

In some implementations, a UE may receive a RRC signaling/message including a configuration for indicating the more than one BWPs and/or the more than one CCs.

In some implementations, the more than one CCs may refer to a PCell, SCell, SPcell, and/or PSCell.

In some implementations, a CC list may include one or more than one CC and each CC list may correspond to a specific RRC signaling.

In some implementations, the more than one CCs may refer to the serving cell and the target cell. A cell index and a BWP index may be indicated by a specific configuration.

The target cell may be indicated by a cell switch command, a PCI index, or a pre-configuration.

Implementations regarding RRC signaling for indicating at least one TCI state for different RSs/channels may include:

In some implementations, the RRC signaling/message may refer to the signaling/message for indicating at least one DL TCI state for at least one active DL BWP, PDSCH, PDCCH, CORESET, CSI-RS, DMRS, a serving cell, and/or a target cell.

In some implementations, the RRC signaling/message may refer to the signaling/message for indicating at least one UL TCI state for at least one active UL BWP, PUCCH, PUSCH, SRS, a target transmission, a target reception, a serving cell, and/or a target cell.

In some implementations, the RRC signaling/message may refer to the signaling/message for indicating at least one joint TCI state for at least one active DL BWP, one active UL BWP, PDSCH, PDCCH, CORESET, CSI-RS, DMRS, PUCCH, PUSCH, a target transmission, a target reception, a serving cell, and/or a target cell.

In some implementations, the UE may receive the RRC signaling from the serving gNB/cell via an RRC message (e.g., RRC reconfiguration message).

In some implementations, the UE may receive the RRC signaling from the source gNB/cell via an RRC message (e.g., RRC reconfiguration message, RRC pre-configuration message) during RRC pre-configuration for Lower-Layer Triggered Mobility (LTM).

In some implementations, whether to enable simultaneous TCI states update for multiple CCs may be explicitly indicated by an RRC parameter.

In some implementations, an IE/RRC parameter may be used to enable simultaneous TCI state update for multiple CCs. For example, if the RRC parameter is set to ‘enabled’, simultaneous TCI states update for multiple CCs is enabled in some scenarios (e.g., mTRP operation with unified TCI framework).

In some implementations, an IE/RRC parameter may be used to enable simultaneous TCI state update for multiple CCs for sTRP operation and/or mTRP operation.

The indication for sTRP operation and mTRP operation may be separately configured.

The indication for sTRP operation and mTRP operation may be configured by one IE/RRC parameter.

### MAC CE for Simultaneous TCI Update on Unified TCI Framework

In some implementations, a MAC CE for updating TCI states simultaneously may apply to all CCs configured in the same CC list.

In some implementations, the MAC CE may be used to activate at least one TCI state for unified TCI framework.
The MAC CE may include the field for indicating TCI states for DL, UL, and/or joint transmission.
The at least one TCI states may include TCI state for sTRP and/or mTRP.

In some implementations, the MAC CE may be used to activate DL/joint TCI state and UL TCI state simultaneously. More specifically, the MAC CE for activating DL/joint TCI state and the MAC CE for activating UL TCI state may be the same.
DL/joint TCI state and UL TCI state may correspond to different fields in the MAC CE.
DL/joint TCI state and UL TCI state may correspond to the same field in the MAC CE. For example, a field might be used to distinguish whether DL/joint TCI state and UL TCI state share the same field or not.

In some implementations, the MAC CE may be used to activate DL/joint TCI state and UL TCI state separately. More specifically, the MAC CE for activating DL/joint TCI state and the MAC CE for activating UL TCI state may be different. A first MAC CE may be used to activate DL/joint TCI state to all CCs and a second MAC CE may be used to activate UL TCI state to all CCs.

In some implementations, all CCs may refer to the activated CCs, the deactivated CCs, the configured CCs and/or the CCs associated with the TCI to be activated. The association between the CCs and the TCI to be activated may be provided in the RRC signaling.

In some implementations, a MAC CE for updating TCI states simultaneously may apply to partial CCs configured in the same or different CC list.

In some implementations, partial CCs in the same CC list may refer to a subset of CCs in the CC list.

In some implementations, the MAC CE may include the index of each of partial CCs.

In some implementations, a bitmap included in the MAC CE may be used to indicate partial CCs in a CC list to apply simultaneous TCI updating. For example, a bit value ‘0’ may mean that the corresponding CC may not be used for simultaneous TCI updating, and a bit value ‘1’ may mean that the corresponding CC may be used for simultaneous TCI updating. The size of the bitmap may be predefined or may be based on the number of CCs in a CC list.

In some implementations, a bitmap included in the MAC CE may be used to indicate partial CCs in different CC lists to apply simultaneous TCI updating. For example, a bit value ‘0’ may mean that the corresponding CC may not be used for simultaneous TCI updating, and a bit value ‘1’ may mean that the corresponding CC may be used for simultaneous TCI updating. The size of the bitmap may be predefined or may be based on the number of CCs in different CC lists.

In some implementations, CCs in different CC list may correspond to a specific group. For example, CC #1 in CC list #1 and CC #3 in CC list #2 may correspond to a first group. CC #1 and CC #2 in CC list #1, CC #4 in CC list #3 may correspond to a second group, where the group may be configured in the RRC signaling.
At least one field in the MAC CE may indicate TCI activation/deactivation for each group. Each bit in the bitmap may correspond to each group.
Each group may correspond to the same TRP scheme (e.g., sTRP, TDM based mTRP, FDM based TRP, SFN, CJT).

In some implementations, a MAC CE for updating TCI states simultaneously may apply to cells with the same number of TCI states.

In some implementations, a first MAC CE for updating single TCI state and a second MAC CE for updating more than one TCI states may be different.

In some implementations, a first MAC CE may refer to sTRP operation and a second MAC CE may refer to mTRP operation.

In some implementations, a MAC CE for updating TCI states simultaneously may apply to signal transmission (e.g., PDCCH, PDSCH, PUSCH and/or PUCCH) or RSs (e.g., CSI-RS, DMRS, SSB and/or SRS) corresponding to the same CORESETPoolIndex.

In some implementations, the MAC CE may include one field for indicating CORESETPoolIndex value. Then, the MAC CE may be used to update/activate TCI state for each signal transmission and/or RSs corresponding to the CORESETPoolIndex value indicated in the MAC CE.

In some implementations, a MAC CE may apply to different channels.

In some implementations, the MAC CE for updating TCI states for different channels may be different. More specifically, the MAC CEs for activating TCI state for each DL channel, and/or the MAC CEs for activating TCI state for each UL channel may be different.

In some implementations, the MAC CE may include at least one field for providing the information related to channel/RSs.

In some implementations, a MAC CE may be used to update cells that share the same TCI states.

In some implementations, the MAC CE may include cell information only.

In some implementations, the latest received MAC CE may update the CCs included in a CC list.

In some implementations, a MAC CE may be used to update cells that share the same TAG ID.

In some implementations, the MAC CE may include one field for indicating a TAG ID. Then, the MAC CE may be used for updating/activating TCI state for each signal transmission and/or RSs corresponding to the TAG ID indicated in the MAC CE.

In some implementations, a MAC CE may be used to update cells that share the same SRS resource set ID.

In some implementations, the MAC CE may include one field for indicating an SRS resource set ID. Then, the MAC CE may be used for updating/activating TCI state for each signal transmission and/or RSs corresponding to the SRS resource set ID indicated in the MAC CE.

In some implementations, a MAC CE may include one or more than one fields for indicating the TCI states update for multiple CCs.

In some implementations, the one or more than one fields may refer to DL TCI state, joint TCI state, and/or UL TCI state.

In some implementations, the one or more than one fields may refer to TCI states for each channel/RS.

### DCI for Simultaneous TCI Update on Unified TCI Framework

In some implementations, DCI with a TCI field may be used to indicate the TCI state to each CC simultaneously or with some delay time.

In some implementations, a first TCI field may be used to indicate the TCI state for a first CC list and a second TCI field may be used to indicate the TCI state for a second CC list.

In some implementations, if a field (e.g., CORESETPoolIndex, SRS resource set indication) included in the DCI indicates sTRP operation (e.g., sTRP based PDSCH/PUSCH transmission) toward the first TRP, a first TCI field may be used to indicate the TCI state for a first CC list and a second TCI field may be ignored.

In some implementations, if a field (e.g., CORESETPoolIndex, SRS resource set indication) included in the DCI indicates sTRP operation (e.g., sTRP based PDSCH/PUSCH transmission) toward the second TRP, a second TCI field may be used to indicate the TCI state for a second CC list and a first TCI field may be ignored.

In some implementations, if a field (e.g., CORESETPoolIndex, SRS resource set indication) included in the DCI indicates mTRP operation (e.g., mTRP based PDSCH/PUSCH transmission) with the transmission order as {the first TRP, the second TRP}, a first TCI field may be used to indicate the TCI state for a first CC list and a second TCI field may be used to indicate the TCI state for a second CC list.

In some implementations, if a field (e.g., CORESETPoolIndex, SRS resource set indication) included in the DCI indicates mTRP operation (e.g., mTRP based PDSCH/PUSCH transmission) with the transmission order as {the second TRP, the first TRP}, a first TCI field may be used to indicate the TCI state for a first CC list and a second TCI field may be used to indicate the TCI state for a second CC list.

In some implementations, if a field (e.g., CORESETPoolIndex, SRS resource set indication) included in the DCI indicates mTRP operation (e.g., mTRP based PDSCH/PUSCH transmission) with the transmission order as {the second TRP, the first TRP}, a first TCI field may be used to indicate the TCI state for a second CC list and a second TCI field may be used to indicate the TCI state for a first CC list.

In some implementations, if a first DCI including CORESETPoolIndex indicates to the UE to perform mTRP operation (e.g., mTRP based PDCCH/PDSCH/PUSCH/PUCCH transmission) and a second DCI without CORESETPoolIndex indicates to the UE to perform sTRP operation (e.g., sTRP based PDCCH/PDSCH/PUSCH/PUCCH transmission), the first DCI may be used to indicate TCI states for the first CC list and the second DCI may be used to indicate TCI state for the second CC list.

In some implementations, a first TCI field may be used to indicate a first TCI state for a CC list and a second TCI field may be used to indicate a second TCI state for the CC list.

The first TCI field and/or the second TCI field may indicate one or more than one TCI states.

In some implementations, the delay time may be based on the beam application time, UE capability, MAC CE, RRC signaling, and/or a number of slots/symbols.

In some implementations, DCI with a TCI field may be used to update one of the indicated TCI states.

In some implementations, when more than one TCI states are indicated by RRC signaling or MAC CE, DCI may indicate one of the TCI states corresponding to one of the TRPs for a CC list.

In some implementations, one of the indicated TCI states may correspond to the TCI state for a specific channel/RS.

In some implementations, one of the indicated TCI states may correspond to the TCI state for a specific channel/RS corresponding to the CORESETPoolIndex associated with the DCI.

In some implementations, the number of bits for different TCI fields in the DCI providing TCI states for multiple CCs may be the same or different.

In some implementations, the TCI fields may refer to TCI update indication for different CC lists.

In some implementations, the TCI fields may refer to TCI update indication for different TRPs in the same CC list.

In some implementations, the TCI fields may refer to TCI update indication for different channels/RSs.

In some implementations, the number of TCI fields in the DCI for providing TCI states for multiple CCs may be the same or different.

In some implementations, the number of TCI fields for a first CC list may be one and the number of TCI fields for a second CC list may be more than one.

In some implementations, DCI with TCI field corresponding to each CC in the same CC list may be consistent.

In some implementations, a first TCI field used to update the TCI state in a first DCI may indicate the same TCI state as that indicated by a second TCI field in a second DCI.

In some implementations, a single DCI may be used to update the at least one TCI state for CCs in the same CC list.

In some implementations, the DCI corresponding to each CC may refer to the same DCI size, the same DCI format, the same scrambling, the same RNTI, the same search space (SS) set, the same CORESET, and/or the same CORESETPoolIndex.

In some implementations, DCI with a TCI field corresponding to each CC in different CC lists may be variable or consistent.

In some implementations, a first TCI field used to update the TCI state in a first DCI may indicate a different TCI state from that indicated by a second TCI field in a second DCI.

In some implementations, a single DCI with more than one TCI fields may be used to update the at least one TCI state for CCs in different CC lists.

In some implementations, the DCI corresponding to each CC may refer to different DCI size, different DCI format, different scrambling, different RNTI, different SS set, different CORESET, and/or different CORESETPoolIndex.

In some implementations, the term “consistent” may mean that the DCI size or the size of TCI field is the same.

In some implementations, the term “variable” may mean that the DCI size or the size of TCI field may be different. For example, padding at least one bit or discarding at least one bit in one of the DCIs may be used to achieve the variable DCI size.

In some implementations, the indicated TCI states for each CC in different CC list may share partial TCI field in DCI. More specifically, TCI field #1 in the DCI may indicate a TCI state for CC #1 in CC list #1 and the TCI state for CC #2 in CC list #2.

### UE Behavior for Simultaneous TCI Update on Unified TCI Framework

In some implementations, a UE may receive a RRC signaling, a MAC CE, and/or DCI from gNB or BS to apply one or more than one indicated TCI states for a set of CCs in the same or different CC list.

In some implementations, a UE may receive a RRC signaling, a MAC CE, and/or DCI to get the information regarding CC list(s).

In some implementations, a UE may apply the same TCI state to receive DL reception or transmit UL transmission to a set of CCs based on the received information.

In some implementations, a UE may apply the same TCI state to all DL channels and/or UL channels in different CCs based on the received information.

In some implementations, a UE may apply the same TCI state to the indicated channels in the same or different CCs based on the received information.

In some implementations, a UE may apply the same TCI state to the CCs in the same or different CC list based on the received information.

In some implementations, a UE may perform a default behavior when the TCI states are not included in the DCI and the MAC CE for a CC or a CC list. For example, the UE may apply the TCI state for the lowest CC index in a CC list.

In some implementations, the TCI state for the lowest CC index may correspond to the TCI state for the DCI in a CORESET with the lowest index.

In some implementations, the TCI state for the lowest CC index may be based on a set of CCs with indicated TCI states.

In some implementations, a UE may perform a default behavior when the DCI for updating TCI state for a CC or a CC list is not received/decoded successfully. In other words, if the UE transmits HARQ-ACK set to NACK or value 0 in response to corresponding DCI, the DCI is not received/decoded successfully, and the default behavior may be performed accordingly. For example, the UE may decode/receive the DCI after transmitting HARQ-ACK. For example, the UE may apply the TCI state for the lowest CC index in a CC list.

In some implementations, applying one or more than one indicated TCI states may mean that receiving DL reception or transmitting UL transmission using the beam from the received TCI state or spatial setting.

In some implementations, the UE may receive an indication to operate in carrier aggregation scheme.

In some implementations, the UE may receive an indication to operate in mTRP scheme.

In some implementations, the UE may receive an indication to operate in unified TCI framework.

In some implementations, the received information may refer to RRC signaling, MAC CE, and/or DCI.

In some implementations, the UE may determine the applied TCI states from one or multiple configured/activated TCI states.

### Base Station Behavior for Simultaneous TCI Update on Unified TCI Framework

In some implementations, a BS may transmit a RRC signaling, a MAC CE, and/or DCI to indicate more than one CCs corresponding to the same TCI state to a UE.

In some implementations, a BS may transmit a RRC signaling, a MAC CE, and/or DCI to indicate one or more than one TCI states to a UE.

In some implementations, a BS may transmit a RRC signaling, a MAC CE, and/or DCI to indicate the information regarding CC list.

In some implementations, a BS may indicate the same TCI state to CCs and indicate which CC may apply the same TCI state.

In some implementations, a BS may indicate the same TCI state to all DL channels or UL channels corresponding to the same or different CCs.

In some implementations, a BS may indicate the same TCI state to the indicated DL channels and/or the indicated UL channels corresponding to the same or different CCs.

In some implementations, a BS may indicate more than one CCs in the same or different list.

In some implementations, a BS may transmit an indication to inform the UE to operate in carrier aggregation scheme.

In some implementations, a BS may transmit an indication to inform the UE to operate in sTRP and/or mTRP scheme.

In some implementations, a BS may transmit an indication to inform the UE to operate in unified TCI framework.

### Simultaneous TCI Update for Inter-Cell Operation

Several scenarios including intra-cell, inter-cell mobility and inter-cell beam management require more aggressive reduction in latency and overhead for better scheduling efficiency and performance. To reduce the latency and signaling overhead while achieving the high data rate, it is significant and necessary to study the inter-cell mobility and inter-cell beam management especially in mTRP operation.

To support higher UE speed scenarios and/or a larger number of beam information for inter-cell scenarios, a UE may only transmit to or receive from only a single cell. However, measuring the quality of beams from other cells may facilitate more efficient DL/UL beam management and/or smoother handover operation. Consequently, how to identify L1 measurement/reporting and beam indication associated with cell(s) with any PCI for multiple cells needs to be specified. Furthermore, when different cells share similar channel characteristics or beam properties, simultaneous beam information update to reduce signaling overhead may need to be considered.

Implementations for handling simultaneous TCI update for multiple BWPs/CCs upon inter-cell mobility and inter-cell beam indication scenarios, but not limited thereto, are disclosed.

One or more TCI state(s) may be applied to a set of BWPs/CCs for signaling overhead reduction since there is no need to configure applicable TCI states for each BWP/CC. In other words, when multiple BWPs/CCs share similar channel conditions, doppler shift, doppler spread, average delay, delay spread, source signaling location, or beam direction, the same set of TCI states may be simultaneously indicated/updated to all CC in the same CC list, and hence some signaling from gNB may be used to inform the specific details regarding how multiple BWPs/CCs share the applicable TCI states information together. Also, the UE may apply the indicated TCI state(s) to one or to a set of CCs/DL BWPs/UL BWPs with or without receiving the unified TCI framework indication. On the other hand, simultaneous TCI update may not only apply to CA scenarios, but also apply to inter-cell beam management and inter-cell mobility scenarios when channel conditions from the serving cell(s) and the non-serving cell(s) are similar, where the inter-cell scenarios may include intra-DU, inter-DU, intra-CU, inter-CU, intra-frequency, and/or inter-frequency cases.

Besides, multiple TRP operation for inter-cell scenarios may prevent beams from being blocked toward a single direction, and thus each TRP associated with different cells, but with similar channel conditions may refer to the same beam indication. For example, a first TRP may be associated with a first cell (e.g., serving cell, PCell, SpCell, PSCell, source cell) or a first PCI (e.g., serving cell PCI, PCI associated with the serving cell, PCI associated with the target cell, PCI associated with the source cell, PCI associated with a PCell, PCI associated with a SpCell, PCI associated with a PSCell) and a second TRP may be associated with a second cell or a second PCI (e.g., target cell, secondary cell, cell with an additional PCI different from that of the serving cell, an additional PCI different from that of the serving cell). It should be noted that the first cell/the first PCI and the second cell/the second PCI are changeable and may refer to intra-frequency scenario or inter-frequency scenario, where the ‘first’ and the ‘second’ mentioned here do not imply the priority or the order of the mentioned cells. In addition, the first TRP and the second TRP may be associated with the same cell but correspond to different TCI states.

### Potential Scenarios

In some implementations, at least two TRPs from a plurality of cells may be associated with a UE, where each TRP is in a different cell.

In some implementations, multiple TRPs may be associated with one of a plurality of cells, and each TRP from the multiple TRPs may be associated with one of the plurality of cells. For example, a first TRP may be associated with a first CC and a second CC and a second TRP may be associated with a third CC and a fourth CC.

In some implementations, one of a plurality of cells may be associated with at least two TRPs and one of a plurality of cells may be associated with a single TRP. For example, a first TRP and a second TRP may be associated with a first CC and the first TRP may be associated with a second CC as well.

In some implementations, a single TRP may be associated with a plurality of cells. For example, a first TRP may be associated with a first CC and a second CC.

In some implementations, the plurality of cells may refer to a plurality of serving cells (e.g., PCell, SpCell, PSCell, SCell) in a CA scenario or in a DC scenario.

In some implementations, the plurality of cells may refer to at least one source cell (e.g., original serving cell) and at least one target cell (e.g., new serving cell).

In some implementations, the plurality of cells may refer to (or be associated with or be identified by) different PCI values. For example, the plurality of cells may be identified by different serving cell indexes or different PCI indexes. Each serving cell index, or each PCI index may be associated with a PCI value.

In some implementations, one of the at least two TRPs may be associated with more than one cells, and the more than one cells may refer to (or be associated with or be identified by) different PCI values. For example, the more than one cells may be identified by different serving cell indexes or different PCI indexes. Each serving cell index or each PCI index may be associated with a PCI value.

In some implementations, the plurality of cells may correspond to intra-DU, inter-DU, intra-CU, inter-CU, intra-frequency, and/or inter-frequency operation.

It should be noted that a TRP may correspond to a source cell or one of the candidate target cells. The source cell or one of the candidate target cells may be configured with a PCI value, a PCI index and/or an additional PCI index.

### RRC Signaling for Inter-Cell Operation

In some implementations, a RRC message that indicates simultaneous TCI update for multiple cells may refer to a pre-configuration, a TCI configuration, a RRC parameter/IE, a list of CCs, and/or a cell switching command.

In some implementations, a pre-configuration may refer to an RRCReconfiguration message and/or a RRC message for providing a pre-configuration for LTM operation.

In some implementations, the pre-configuration may include at least one TCI configuration for at least one cell.

The at least one cell may refer to a serving cell, a candidate cell, a cell with PCI different from the serving cell, a target cell, or a source cell.

In some implementations, the pre-configuration may include at least one CC list information to indicate the same TCI state for the cells in the at least one CC list.

In some implementations, the pre-configuration may include more than one TCI configurations, and each of the more than one TCI configurations may be associated with one cell or one CC list.

In some implementations, the pre-configuration may be associated with a PCI value/additional PCI index.

In some implementations, the number of TCI configurations in the pre-configuration may be the same or different between different pre-configurations if each pre-configuration is associated with a PCI index.

In some implementations, at least one TCI configuration may be specific to indicating TCI states for at least one cell other than the serving cell.

In some implementations, the at least one TCI configuration may include at least one TCI state, at least one TCI state group, and/or the association between the TCI state and the PCI value.

Each of the at least one TCI state group may correspond to different number of TRPs. For example, a first TCI state group may refer to single TRP and a second TCI state group may refer to multiple TRPs.

The TCI state group may include one or more than one TRPs, where each TRP may correspond to a single TCI state.

In some implementations, at least one RRC parameter may provide information of the association between the TRP and the cell.

In some implementations, the association may refer to an indication to determine whether to apply a reference TCI state to the at least one cell other than the serving cell.

The reference TCI state may refer to the TCI state of the serving cell, the TCI state of the source cell, and/or the TCI state of a reference cell.

In some implementations, the association may refer to an indication of cell index, an indication of CC list index, and/or an indication of the PCI value.

In some implementations, the association may refer to a table with multiple entries. The entries may include information of TCI state, the number of TCI states, and/or the associated cell.

In some implementations, a list of CCs may refer to different CC groups. For example, a list of CCs may correspond to at least one CC group (e.g., a single CC group, and/or a first CC group and a second CC group).

In some implementations, the CC group may (only) include at least one serving cell, candidate cell, source cell, target cell, or the indicated cell.

In some implementations, the CC group may include at least one serving cell, and/or partial/all candidate cells.

In some implementations, the CC group may include at least one serving cell, and/or all indicated cells.

In some implementations, the CC group may include at least one serving cell, and/or target cell.

In some implementations, the CC group may be indicated based on the types of cells (e.g., serving cell, non-serving cell, PCell, PSCell, SpCell, SCell, source cell, target cell), the associated TRPs (e.g., mTRP, sTRP), the configured scheme (e.g., TDM, FDM, SDM, SFN, STxMP, unified TCI framework, beam failure detection, inter-cell beam management, inter-cell mobility), the UL transmission types (e.g., codebook based, non-codebook based), the SRS resource set usage (e.g., beam management, antenna switching), and/or CSI resource set type (e.g., beam management, RRM measurement, interference measurement, CSI report, CSI resource for mobility).

In some implementations, a list of CCs may include the indicated cell(s), the candidate cell(s), the serving cell, and/or the target cell.

In some implementations, the cell switching command may include information for the target cell, for partial/all candidate cells, for a specific cell group.

In some implementations, the information may refer to TCI state indication, the number of TCI states, a flag regarding whether to apply multiple TRP operation, a flag regarding whether to apply unified TCI framework, a flag regarding whether to apply a reference TCI state, a flag regarding whether to apply simultaneous TCI state update, a PCI value, a cell index, a CC list index, and/or TCI state group index.

In some implementations, an RRC message may indicate that the pre-configuration is for scheduling information for at least one cell in CA or DC operation.

In some implementations, the TCI state in the pre-configuration may be associated with one MAC entity or more than one MAC entities.

In some implementations, after the UE receives the RRC message, the UE may store, configure and/or apply the information/configuration included in the RRC message.

In some implementations, an RRC message may associate more than one CC lists with different cells from different frequency bands. For example, a first CC list may include multiple cells in intra-frequency band and a second CC list may include multiple cells in inter-frequency band. For example, a first CC list may include multiple cells in a first frequency band and a second CC list may include multiple cells in a second frequency band.

In some implementations, a TCI state may correspond to one or more than one PCI index.

In some implementations, more than one TCI states may correspond to one single PCI index.

### MAC CE for Inter-Cell Operation

In some implementations, a MAC CE that indicates simultaneous TCI update for multiple cells may refer to a cell switching command, a MAC CE for indicating TCI state associated with PCI other than the PCI of the serving cell, a MAC CE for indicating TCI state configuration of the target cell, and/or a MAC CE for indicating TCI state configuration of the candidate cell.

In some implementations, a MAC CE may update the indicated TCI state from the pre-configuration. For example, the MAC CE may update or override the indicated TCI state or CC list received from the pre-configuration.

In some implementations, a MAC CE may include at least one field to provide information for simultaneous TCI state update.

In some implementations, the information may include the index of the TCI states, the index of the TCI states in the RRC message, the serving cell index, the additional PCI index, the CC list (group) index, and/or the PCI index.

In some implementations, at least one MAC CE field or bitmap may be mapped to TCI state for one or more than one CCs. For example, a field with CC index/a CC list index and one or more than one fields with activation/deactivation status (e.g., bit ‘1’ represents activation and bit ‘0’ represents deactivation) for corresponding TCI state index may indicate the applied TCI state for the CC index/the CC list. For example, a field with CC index/a CC list index and one or more than one fields TCI state index may indicate the applied TCI state for the CC index/the CC list.

In some implementations, a MAC CE for beam indication may also refer to a cell switch command.

In some implementations, a MAC CE for beam indication may be different from a cell switch command. For example, the MAC CE for beam indication may be received by a UE before or after the cell switch command.

In some implementations, a MAC CE may provide the TCI state of multiple cells and apply the indicated TCI state to the multiple cells.

In some implementations, the multiple cells may refer to all serving cells based on the reported UE capability (e.g., support CA or DC operation).

In some implementations, the multiple cells may refer to at least a source cell and at least a target cell.

In some implementations, the multiple cells may refer to partial/all candidate cells.

In some implementations, the MAC CE may be applied to a plurality of cells associated with multiple TRPs.

In some implementations, the MAC CE may be applied to a plurality of cells associated with single TRP.

In some implementations, different MAC CEs may be used to indicate mTRP operation and sTRP operation separately. For example, a first MAC CE may apply an indicated TCI state to a first set of cells and a second MAC CE may apply more than one indicated TCI states to a second set of cells.

In some implementations, after the UE receives the MAC CE, the UE may store, configure and/or apply the information/configuration included in the MAC CE.

In some implementations, a plurality of cells may correspond to the same MAC entity or different MAC entities.

### DCI for Inter-Cell Operation

In some implementations, DCI that indicates simultaneous TCI update for multiple cells may be used to indicate one of the TCI states from the RRC message and/or the MAC CE or update/revise the indicated TCI state which is originally indicated by the RRC message and/or the MAC CE.

In some implementations, the DCI may include at least one field for indicating at least one TCI state for more than one CCs to update TCI state for the indicated CCs.

In some implementations, a dedicated DCI format may schedule data or beam information for more than one CCs to update TCI state of received data on the indicated CCs for a UE.

In some implementations, a DCI format scrambled by a dedicated RNTI may schedule data or beam information for more than one CCs to update TCI state of received data on the indicated CCs for the UE. In some implementations, the DCI may refer to a DCI format specific to indicating beam information for at least one serving cell, at least one source cell, at least one cell other than the serving cell, at least one target cell, and/or at least one candidate cell.

In some implementations, the DCI may refer to a DCI format specific to scheduling a DL reception or a UL transmission for at least one serving cell, at least one source cell, at least one cell other than the serving cell, at least one target cell, and/or at least one candidate cell.

In some implementations, the DCI may refer to a DCI format with CRC scrambled by a specific RNTI, and the DCI format may be associated with beam indication.

In some implementations, the DCI may refer to a cell switching command.

In some implementations, the cell switching command may include information of TCI state, the information of the applied cell.

In some implementations, after the UE receives the DCI, the UE may store, configure and/or apply the information/configuration included in the DCI.

### UE Behavior for Inter-Cell Operation

In some implementations, a UE may receive an RRC message, a MAC CE, and/or DCI comprising beam information and/or the cell information from a BS and further receive another DCI that schedules a DL reception or a UL transmission.

In some implementations, the received RRC message, MAC CE, and/or DCI may be used to indicate beam information for at least two serving cells.

In some implementations, the received RRC message, MAC CE, and/or DCI may be used to indicate beam information for at least one source cell and/or at least one target cell.

In some implementations, the received RRC message, MAC CE, and/or DCI may be used to indicate beam information for at least one source cell, at least one target cell, and/or at least one candidate cell.

In some implementations, the received RRC message, MAC CE, and/or DCI may be used to indicate beam information for at least one serving cell, and/or at least one indicated cell other than the serving cell.

In some implementations, the UE may apply the at least one beam information simultaneously or with some time delay to the DL reception and/or the UL transmission on at least two serving cells.

In some implementations, the UE may apply the at least one beam information simultaneously or with some time delay to the DL reception, the UL transmission, the DL reception to be received and/or the UL transmission on at least at least one source cell and/or at least one target cell.

In some implementations, the UE may apply the at least one beam information simultaneously or with some time delay to the DL reception, the UL transmission, the DL reception to be received and/or the UL transmission on at least one source cell, at least one target cell, and/or at least one candidate cell.

In some implementations, the UE may apply the at least one beam information simultaneously or with some time delay to the DL reception, the UL transmission, the DL reception to be received and/or the UL transmission on at least one serving cell, and/or at least one indicated cell other than the serving cell.

In some implementations, the time delay may be based on the reported UE capability.

In some implementations, the time delay may be based on a value indicated in the RRC message.

In some implementations, the time delay may be based on a value indicated in the MAC CE.

In some implementations, the time delay may be based on the number of configured candidate cells, the measurement result of at least one candidate cell, and/or the measurement result of at least one target cell.

In some implementations, the UE may receive the RRC message, the MAC CE, and the DCI in a predetermined order.

In some implementations, the UE may receive the RRC message first and receive the MAC CE after receiving the RRC message.

In some implementations, the UE may receive the RRC message first and receive the DCI after receiving the RRC message.

In some implementations, the UE may receive the MAC CE message first and receive the DCI after receiving the MAC CE message.

In some implementations, a UE may receive the RRC message first, receive the MAC CE after receiving the RRC message, and then receive the DCI.

In some implementations, the order in which the RRC message, the MAC CE, and the DCI are received may be determined based on the priority. For example, the RRC message, the MAC CE and the DCI may have a specific priority, and the UE may first receive signaling with higher priority.

In some implementations, the UE may report a capability to inform the BS whether to support simultaneous TCI update for a list of cells.

In some implementations, the list of cells may include at least one serving cell, at least one source cell, at least one cell other than the serving cell, at least one target cell, and/or at least one candidate cell.

In some implementations, a DL reception may refer to a PDCCH, a PDSCH, a CSI-RS, a PT-RS and/or a DM-RS.

In some implementations, a UL transmission may refer to a PUCCH, a PUSCH, and/or an SRS.

In some implementations, the UE may report the capability in response to the reception of a UE capability enquiry message from the BS.

In some implementations, the UE may apply the indicated TCI state(s) for a plurality of cells in a first frequency band and apply the indicated TCI state(s) for a plurality of cells in a first frequency band after a certain duration, where the certain duration may correspond to a value indicated by an RRC configuration, an RRC parameter, an RRC IE, a MAC CE, a DCI field, and/or a pre-defined value in symbol unit, in slot unit, in millisecond unit, in second unit.

In some implementations, the UE may receive a cell switch command to indicate which cell is a target cell, and then the UE may receive the indicated TCI state from the cell switch command during the time that the UE processes the cell switch command.

In some implementations, the UE may receive the pre-configuration to receive the information of TCI states for all candidate cells before the UE receives the cell switch command.

In some implementations, the UE may receive the pre-configuration to receive the information of TCI states for the target cell(s) before the UE receives the cell switch command.

In some implementations, the UE may receive the indication to receive the information of TCI states for the target cell(s) during DL synchronization procedure.

In some implementations, the UE may receive the indication to receive the information of TCI states for the target cell(s) during UL synchronization procedure.

In some implementations, the UE may receive the indication to receive the information of TCI states for the target cell(s) during RAR or after receiving RAR.

In some implementations, the UE may apply the indicated TCI states to the target CC(s) when processing the cell switch command.

In some implementations, the UE may apply the indicated TCI states to the target CC(s) during a DL synchronization procedure.

In some implementations, the UE may apply the indicated TCI states to the target CC(s) during a UL synchronization procedure.

In some implementations, the UE may apply the indicated TCI states to the target CC(s) during RAR or after receiving RAR.

### BS Behavior for Inter-Cell Operation

In some implementations, a BS may transmit an RRC message, a MAC CE, and/or DCI including beam information and/or the cell information to a UE and further transmit DCI to schedule a DL reception or a UL transmission.

In some implementations, the received RRC message, MAC CE, and/or DCI may be used to indicate beam information for at least two serving cells.

In some implementations, the received RRC message, MAC CE, and/or DCI may be used to indicate beam information for at least one source cell and/or at least one target cell.

In some implementations, the received RRC message, MAC CE, and/or DCI may be used to indicate beam information for at least one source cell, at least one target cell, and/or at least one candidate cell.

In some implementations, the received RRC message, MAC CE, and/or DCI may be used to indicate beam information for at least one serving cell, and/or at least one indicated cell other than the serving cell.

In some implementations, the BS may receive a transmission with the indicated beam information from the UE.

In some implementations, the BS may transmit an RRC message to provide scheduling information of at least one target cell to the UE. More specifically, the BS may provide information of a DL reception to be transmitted and a UL transmission to be received to the cell other than the serving cell.

In some implementations, the BS may transmit the RRC message, the MAC CE, and the DCI in a predetermined order.

In some implementations, the BS may transmit the RRC message first and transmit the MAC CE after transmitting the RRC message.

In some implementations, the BS may transmit the RRC message first and transmit the DCI after transmitting the RRC message.

In some implementations, the BS may transmit the MAC CE message first and transmit DCI after transmitting the MAC CE message.

In some implementations, the BS may transmit the RRC message first, transmit the MAC CE after transmitting the RRC message, and transmit the DCI.

In some implementations, the order in which the RRC message, the MAC CE, and the DCI are transmitted may be determined based on the priority. For example, the RRC message, the MAC CE and the DCI may have a specific priority, and the UE may receive signaling with higher priority.

In some implementations, the BS may receive a UE capability regarding whether to support simultaneous TCI update for a list of cells and transmit beam information to the UE based on the UE capability.

In some implementations, the list of cells may include at least one serving cell, at least one source cell, at least one cell other than the serving cell, at least one target cell, and/or at least one candidate cell.

In some implementations, the DL reception may refer to a PDCCH, a PDSCH, a CSI-RS, a PT-RS and/or a DM-RS.

In some implementations, the UL transmission may refer to a PUCCH, a PUSCH, and/or an SRS.

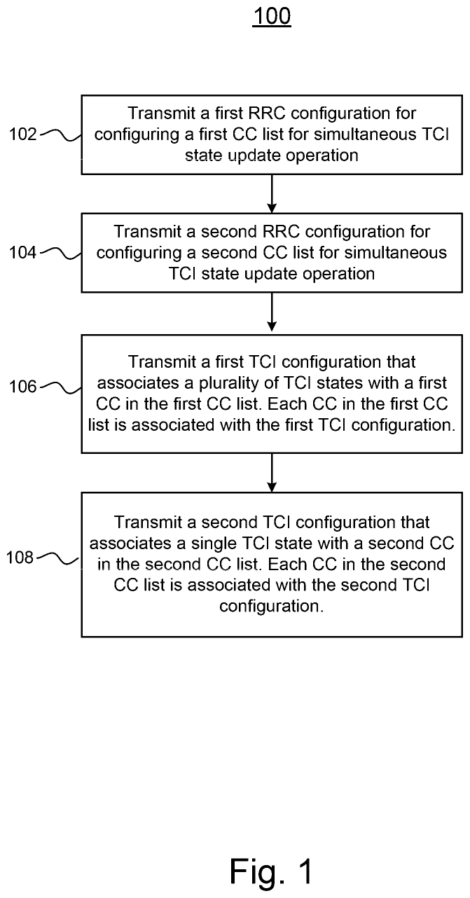

FIG. 1 is a flowchart 100 illustrating a method/process for a simultaneous TCI state update operation performed by a BS, according to an example implementation of the present disclosure. In action 102, the BS may transmit (for example, to a UE) a first RRC configuration for configuring a first CC list for simultaneous TCI state update operation. In action 104, the BS may transmit (for example, to the UE) a second RRC configuration for configuring a second CC list for simultaneous TCI state update operation.

In action 106, the BS may transmit (for example, to the UE) a first TCI configuration that associates a plurality of TCI states with a first CC in the first CC list. Each CC in the first CC list may be associated with the first TCI configuration. For example, the UE may apply the same plurality of TCI states in each cell in the first CC list as in the first CC, thus achieving simultaneous TCI state update. The first CC list may correspond to the mTRP operation.

In action 108, the BS may transmit (for example, to the UE) a second TCI configuration that associates a single TCI state with a second CC in the second CC list. Each CC in the second CC list may be associated with the second TCI configuration. For example, the UE may apply the same single TCI state in each cell in the second CC list as in the second CC, thus achieving simultaneous TCI state update. The second CC list may correspond to the sTRP operation.

The technical problem addressed by the method illustrated in FIG. 1 is efficient TCI state update and configuration of the corresponding CC lists within a communication system. In particular, one CC list may be specific to the mTRP operation and the other CC list may be specific to the sTRP operation. The advantageous technical effect achieved by the method illustrated in FIG. 1 is reducing scheduling overhead for carrier aggregation operation and providing more efficient method to indicate beam information when a specific scheme (e.g., singe TRP scheme or multiple TRP scheme) is applied to a set of CCs. This allows for a more efficient scheduling in a communication system, leading to enhanced beam indication method and improved efficiency for scheduling different scheme in carrier aggregation operation.

In some implementations, the first CC list and the second CC list may correspond to different RRC parameters. For example, the first CC list and the second CC list may correspond to separate RRC IEs respectively.

In some implementations, the first CC may correspond to a first reference cell for the first CC list, and the second CC may correspond to a second reference cell for the second CC list. Other cells in the first CC list may update their multiple TCI states according to the first reference cell. Similarly, other cells in the second CC list may update their single TCI state according to the second reference cell.

In some implementations, no TCI state configuration is configured to any CC in the first CC list other than the first CC, and no TCI state configuration is configured to any CC in the second CC list other than the second CC. In other words, in the first CC list, only the first CC is configured with the first TCI configuration. In the second CC list, only the second CC is configured with the second TCI configuration.

In some implementations, the single TCI state indicated by the second TCI configuration may be a DL TCI state, a joint TCI state, or a UL TCI state. In some implementations, the plurality of TCI states indicated by the first TCI configuration may be a pair of DL TCI states, a pair of joint TCI states, a pair of UL TCI states, or a pair of DL/UL TCI states. In other words, the unified TCI framework may be applied to the cells in the second CC list and/or the first CC list.

In some implementations, at least one of the first RRC configuration or the second RRC configuration may be included in an RRC reconfiguration message.

In some implementations, at least one CC in the first CC list or in the second CC list corresponds to a non-serving cell. For example, the first CC list and/or the second CC list may include an indicated cell, a candidate cell, and a target cell (e.g., for inter-cell mobility).

In some implementations, the first CC may correspond to a first serving cell index and the second CC may correspond to a second serving cell index.

In some implementations, the method further includes transmitting a first MAC CE for activating the plurality of TCI states for all CCs in the first CC list and transmitting a second MAC CE for activating the single TCI state for all CCs in the second CC list. In other words, the second MAC CE for updating the single TCI state and the first MAC CE for updating the plurality of TCI states may be different.

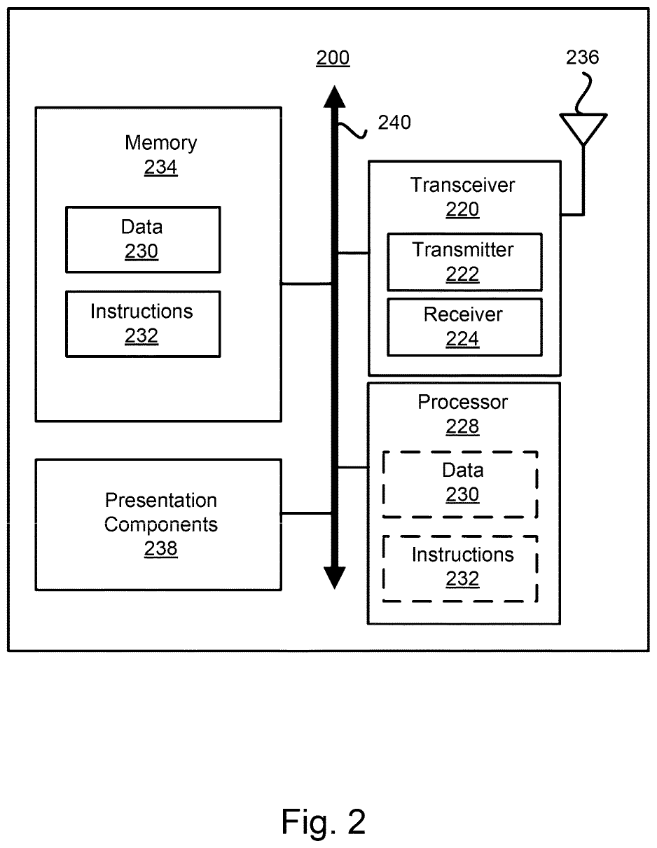

FIG. 2 is a block diagram illustrating a node 200 for wireless communication in accordance with various aspects of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a network communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including, but not limited to, usable, non-usable, and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable instructions 232 (e.g., software codes) that are configured to, when executed, cause the processor 228 to perform various functions disclosed herein, for example, with reference to FIG. 1. Alternatively, the instructions 232 may not be directly executable by the processor 228 but may be configured to cause the node 200 (e.g., when compiled and executed) to perform various functions disclosed herein.

The processor 228 (e.g., having processing circuitry) may include an intelligent hardware device, e.g., a Central Processing Unit (CPU), a microcontroller, an ASIC, etc. The processor 228 may include memory. The processor 228 may process the data 230 and the instructions 232 received from the memory 234, and information transmitted and received via the transceiver 220, the baseband communications module, and/or the network communications module. The processor 228 may also process information to send to the transceiver 220 for transmission via the antenna 236 to the network communications module for transmission to a CN.

One or more presentation components 238 may present data indications to a person or another device. Examples of presentation components 238 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

1. A method performed by a Base Station (BS) for performing a simultaneous Transmission Configuration Indication (TCI) state update operation, the method comprising:
transmitting, to a user equipment (UE), a first Radio Resource Control (RRC) configuration for configuring a first component carrier (CC) list for the simultaneous TCI state update operation;
transmitting, to the UE, a second RRC configuration for configuring a second CC list for the simultaneous TCI state update operation;
transmitting, to the UE, a first TCI state configuration that indicates a plurality of TCI states associated with a first CC in the first CC list;
transmitting, to the UE, a second TCI state configuration that indicates a single TCI state associated with a second CC in the second CC list; and
receiving, from the UE, a first Physical Uplink Shared Channel (PUSCH) based on the first TCI state configuration, or a second PUSCH based on the second TCI state configuration,
wherein each CC in the first CC list is associated with the first TCI state configuration, and each CC in the second CC list is associated with the second TCI state configuration.

2-10. (canceled)

11. A base station (BS) for performing a simultaneous Transmission Configuration Indication (TCI) state update operation, the BS comprising:
at least one processor; and
at least one non-transitory computer-readable medium coupled to the at least one processor and storing one or more computer-executable instructions that, when executed by the at least one processor, cause the BS to;
transmit, to a User Equipment (UE), a first Radio Resource Control (RRC) configuration for configuring a first component carrier (CC) list for the simultaneous TCI state update operation;
transmit, to the UE, a second RRC configuration for configuring a second CC list for the simultaneous TCI state update operation;
transmit, to the UE, a first TCI state configuration that indicates a plurality of TCI states associated with a first CC in the first CC list;
transmit, to the UE, a second TCI state configuration that indicates a single TCI state associated with a second CC in the second CC list, and
receive, from the UE, a first Physical Uplink Shared Channel (PUSCH) based on the first TCI state configuration, or a second PUSCH based on the second TCI state configuration,
wherein each CC in the first CC list is associated with the first TCI state configuration, and each CC in the second CC list is associated with the second TCI state configuration.

12. The BS of claim 11, wherein the first CC list and the second CC list correspond to different RRC parameters.

13. The BS of claim 11, wherein the first CC corresponds to a first reference cell for the first CC list, and the second CC corresponds to a second reference cell for the second CC list.

14. The BS of claim 11, wherein no TCI state configuration is configured to any CC in the first CC list other than the first CC, and no TCI state configuration is configured to any CC in the second CC list other than the second CC.

15. The BS of claim 11, wherein the single TCI state indicated by the second TCI state configuration is a Downlink (DL) TCI state, a joint TCI state, or an Uplink (UL) TCI state.

16. The BS of claim 11, wherein the plurality of TCI states indicated by the first TCI state configuration comprises a pair of Downlink (DL) TCI states, a pair of joint TCI states, a pair of Uplink (UL) TCI states, or a pair of DL/UL TCI states.

17. The BS of claim 11, wherein at least one of the first RRC configuration or the second RRC configuration is included in an RRC reconfiguration message.

18. The BS of claim 11, wherein at least one CC in the first CC list or in the second CC list corresponds to a non-serving cell.

19. The BS of claim 11, wherein the first CC corresponds to a first serving cell index and the second CC corresponds to a second serving cell index.

20. The BS of claim 11, wherein the one or more computer-executable instructions, when executed by the at least one processor, further cause the BS to:
transmit, to the UE, a first Medium Access Control (MAC) Control Element (CE) for activating the plurality of TCI states for all CCs in the first CC list; and
transmit, to the UE, a second MAC CE for activating the single TCI state for all CCs in the second CC list.

21. A user equipment (UE) for performing a simultaneous Transmission Configuration Indication (TCI) state update operation, the UE comprising:
at least one processor; and
at least one non-transitory computer-readable medium coupled to the at least one processor and storing one or more computer-executable instructions that, when executed by the at least one processor, cause the UE to:
receive, from a Base Station (BS), a first Radio Resource Control (RRC) configuration for configuring a first component carrier (CC) list for the simultaneous TCI state update operation;
receive, from the BS, a second RRC configuration for configuring a second CC list for the simultaneous TCI state update operation;
receive, from the BS, a first TCI state configuration that indicates a plurality of TCI states associated with a first CC in the first CC list;
receive, from the BS, a second TCI state configuration that indicates a single TCI state associated with a second CC in the second CC list; and
transmit, to the BS, a first Physical Uplink Shared Channel (PUSCH) based on the first TCI state configuration, or a second PUSCH based on the second TCI state configuration,
wherein each CC in the first CC list is associated with the first TCI state configuration, and each CC in the second CC list is associated with the second TCI state configuration.

22. The UE of claim 21, wherein the first CC list and the second CC list correspond to different RRC parameters.

23. The UE of claim 21, wherein no TCI state configuration is configured to any CC in the first CC list other than the first CC, and no TCI state configuration is configured to any CC in the second CC list other than the second CC.

24. The UE of claim 21, wherein the one or more computer-executable instructions, when executed by the at least one processor, further cause the UE to:
receive, from the BS, a first Medium Access Control (MAC) Control Element (CE) for activating the plurality of TCI states for all CCs in the first CC list; and
receive, from the BS, a second MAC CE for activating the single TCI state for all CCs in the second CC list.
